(19) United States
(12) Patent Application Publication
(10) Pub. No.: US 2009/0055837 A1
(43) Pub. Date: Feb. 26, 2009

(54) Real-Time Distributed Processor Environment

(75) Inventor: Eric Ralph Campbell, Hertfordshire (GB)

Correspondence Address: BUCHANAN, INGERSOLL & ROONEY PC, POST OFFICE BOX 1404, ALEXANDRIA, VA, 22313-1404, US

(73) Assignee: MBDA UK Limited, Stevenage, Hertfordshire (GB)

(21) Appl. No.: 12/280,465

(22) PCT Filed: Feb. 22, 2007
(86) PCT No.: PCT/GB2007/000624

§ 371 Date: Aug. 22, 2008

(30) Foreign Application Priority Data
Feb. 24, 2006 (EP) 06270021.6
Feb. 24, 2006 (GB) 0603720.4

(51) Int. Cl. G06F 9/46

(52) U.S. Cl. 719/313

(57) ABSTRACT

A real-time distributed processing environment for supporting the execution of interacting activities in different processors, comprising a network of message-passing elements for transferring data between memory areas of the processors; and route-table means associated with each message-passing element within the distributed processing environment, the route-table means comprising programmable variables for a set of software-routes that are to be supported by the associated message-passing device, wherein software-route data associated with a software activity producing data and a software activity using the data may be transferred between memory devices concurrently with execution of activities by the processors. The environment allows the processors to commence or continue execution of any activity simultaneously with the movement of software-route data between the memory spaces of the processors without any involvement from software. the route-table effectively decouples in time, the movement of data by the message-passing electronics from the execution of the activities and any of their associated software-route access procedures that are running on the processors.

The present invention relates to the field of computer architecture and, in particular, to an environment that facilitates the implementation and autonomous movement of data associated with software-route interaction protocols by message-passing electronics in a real-time distributed processor environment.

In distributed multi-processor systems, the performance of the overall system is often reduced by the use of a complex operating system that is needed to manage communications between tasks executing on different processors. In conventional computing architectures, the execution of application software on processing nodes is facilitated by a software operating system; communication between processing nodes is realised by a separate communication system using some form of message-passing electronics; and an interface to the communication system is provided at each processing node. Independent evolutions have resulted in multi-tasking operating systems and high performance communication systems, which do not naturally fit together to support interaction between individual application tasks (activities) executing on different processing nodes. Typically, each such interaction would invoke several layers of operating system software at each processor/communication interface, for message queuing, message multiplexing and de-multiplexing, managing the communication system interface and dealing with its interrupts. Conventional electronic message passing naturally supports “shared process” type interactions in that active participation by the sender and the receiver is required in order to effect a successful message transfer. Shared process type interactions always force synchronisation between tasks because data can only exist within a process. Such conventional architectures introduce complexity and, the executing application tasks suffer temporal interference and disruption, whilst the operating system uses processor time, when managing communications and handling the associated interrupts.

GB-A-2112553 discloses a data communication arrangement which uses an interface processor to DMA data from and to the memory of different processors. An interface program, referred to as the “interface processor unit message handler”, is required on each main process, which runs under control of its local operating system. The “interface processor unit message handler” is called by the operating system in response to either an application task call that requires a remote interaction, or each time an incoming message is delivered by the interface processor. This arrangement is complex and suffers the temporal disruption described above.

WO-A-03/017126 A1 discloses a mechanism for configuring the connections between a computer's system resources. The mechanism requires a service processor (or equivalent) that operates as an external supervising intelligence and the use of conventional operating system functions executing on each processor and so suffers the associated complexity and temporal disruption. The mechanism uses ‘routing tables’ between the service processor and operating system functions executing on each processor to control and isolate various system resources, each ‘routing table’ entry associating the address for a resource with a processor and with the link to reach the processor. US-A-2004/0100904 and EP-A-0522683 disclose mechanisms that enable messages to be passed between processors in a distributed network via a network of routing points. The routers referred to in both mechanisms form past of a message-passing electronics to effect a point to point message transfer between pairs of processor nodes.

U.S. Pat. No. 5,446,915 discloses the use of a connection table to maintain virtual connections (i.e. conventional message-passing paths) between pairs of user processes that are located in different processor nodes. Each message transfer requires active involvement by both software processes. From a software architectural viewpoint, the virtual connection provides a ‘rendezvous’ interaction, requiring both software processes to ‘meet’ (i.e. be at the appropriate point in their individual execution threads) at the time of data exchange. At the point of interaction, the message-passing mechanism moves data from one software process to the other software process, in a ‘shared process’ interaction. As described above, the tight synchronisation implicit in a ‘shared process’ interaction is undesirable for embedded real-time systems. In addition, the virtual connection protocol generate interrupts that involve operating system interrupt handling, unless the software processes at each end have both been scheduled to execute between each message-transfer. The temporal effects of these interrupts and/or extra scheduling constraints are undesirable for embedded real-time systems. The disclosed connection table uses slots to enable the message-passing electronics to handle a sequence of concatenated message transfers between a pair or processor nodes which requires some form of software message handling at each end to assemble/disassemble the set.

MASCOT is a software design method for real-time systems, based on data flow concepts in which there are two fundamental classes of component: activities and intercommunication data areas (IDAs). An activity is a single sequential program thread that can be independently scheduled, while an IDA provides the mechanism for data to pass between different activity components. In Mascot, there are two principle classes of IDA: the POOL form of IDA, which is used to hold reference data; and the CHANNEL form of IDA, which is used to pass messages.

The ROUTE concept, which forms part of the Data Interaction Architecture (DIA) described in EP 0477364, is an important extension of MASCOT. A ROUTE is a special form of IDA, which is used to provide point-to-point communication between an activity that is producing data and an activity that is using the data. ROUTEs are used to express abstract communication designs and can be mapped into hardware in a variety of forms. The abstract designs meet the conditions of defined communication protocols, which in a distributed system will be satisfied, regardless of the relative location of the activities connected by the route.

Communication protocols, which dynamically pass information, are named software-routes, to avoid confusion with the hardware routes (buses or links) that are used to physically move the data. Software-routes are used to express abstract communication designs and may represent communications between activities within a single processor and/or communication between activities located in different processors.

Each software-route has four components: a write access procedure that enables the activity that is producing data to insert a data item; a read access procedure that enables the activity that is using the data to retrieve a data item; some variables whose values are dynamically changed to realise a particular software-route protocol; and some form of data item storage. The data that is to be passed between the activity that is producing data and the activity that is using the data is held in some form of memory. The amount of memory required to hold one complete data item is called a slot. Software-route protocol designs enable concurrent operation of the write access procedure and associated activity that is producing data with the read access procedure and associated activity that is using the data by including more than one slot. For example, one form of protocol design, named an ‘open access’ form may use three slots: one to allow the activity that is producing data to be assembling a new data item; whilst one is holding the most recently written data item; whilst one is allowing the activity that is using the data to still be accessing a previous data item.

EP0292287 describes an algorithm for a four-slot mechanism that allows concurrent execution of a write access procedure and a read access procedure, which imposes no restriction on the start times, durations or overlap of the access procedures. The algorithm realises a type of software-route protocol, known as a Pool, which will be described in more detail later in the specification. Each new data item is put in one of four slots and the algorithm ensures that the activity that is producing data and the activity that is using the data are always directed to different slots, which ensures the data integrity of each data item.

The interface between a software-route access procedure and its associated activity may either be procedural or data, and in each case, single data items are inserted or retrieved, and pass through the route unchanged. The write access procedure forms part of the thread of execution of the activity that is producing data and must execute on the same processor. The read access procedure forms part of the thread of execution of the activity that is using the data and must execute on the same processor. When in a distributed system the write access procedure and the read access procedure for a software-route execute on different processors, the software-route design includes the means to transfer data items between the processor memories.

EP 0477364 describes how a MASCOT style network of independently operating software activities can be executed on a multiple processor, distributed shared-memory platform using a plurality of special hardware devices. Two types of device are used; a kernel integrated circuit (KERIC) supports the scheduling of activities on a processor and a communications integrated circuit (COMIC) supports the interaction of multiple software-routes between processor pairs. The Data Interaction Architecture (DIA) described in EP 0477364, uses a control node mechanism that is suitable for a single processor using co-operative scheduling, the control node mechanism comprising a set of control nodes at which individual activities may wait. Each control node is implemented as a software record, which holds an activity number and a Boolean variable “waiting”. When an activity waits on a particular control node, its number is inserted into the activity number field and the associated Boolean variable “waiting” is set true. The activity is then de-scheduled and the processor is free to execute other activities. At sometime in the future, the control node may be stimmed by a software procedure initiated by another activity. The software procedure reads the control node record. If “waiting” is true, it registers a “current demand for scheduling” on the KEC for the activity number held in the control node, then sets the waiting variable false.

WO 97/22926 discloses an integrated circuit (Butler) that supports the scheduling of activities on a processor within a multiple processor environment, but without the need for software stim-servers or the interrupt handlers found in conventional systems, which suffer from the complexity and temporal interference associated with inter-processor interactions. A control node mechanism is also used, but it is suitable for multiple processors using co-operative or pre-emptive scheduling. The implementation involves using a set of “stim-wait” channels for each activity, each “stim-wait” channel having two Boolean variables, a “stim” bit and a “wait” bit, the values of which are held in the integrated circuit. Each “stim-wait” channel can support an individual control node. When an activity waits on a particular control node, the associated Boolean variable “wait” is set true and when a particular control node is stimmed, the associated Boolean variable “stim” is set true. By holding the stim and wait bits for all interactions involving activities running on a processor, both internal interactions and external interactions, the butler can select the next activity that should run, taking into account all interactions. This avoids the disruption caused in a conventional system where activity execution is suspended to allow the operating system to execute on the processor to deal with the interrupts associated with external interactions.

However, there still exists a need to minimize the effects of data movement associated with software-route interaction protocols on overall system performance.

It is an object of the present invention to provide an execution environment that avoids the complexity and temporal disruption associated with an operating system incorporating message-passing mechanisms and associated interrupt handlers used in conventional multiprocessor systems.

It is a further object of the present invention to provide improved integration between message passing elements and software tasking within a distributed processing system.

It is yet a further object of the present invention to eliminate the stringent synchronisation implicit in shared process type interactions found in conventional computing architectures.

From a first aspect, the present invention resides in a real-time distributed processing environment for supporting the execution of interacting activities in different processors, comprising a network of message-passing elements for transferring data between memory areas of the processors; and route-table means associated with each message-passing element within the distributed processing environment, the route-table means comprising programmable variables for a set of software-routes that are to be supported by the associated message-passing device, wherein software-route data associated with a software activity producing data and a software activity using the data may be transferred between memory devices concurrently with execution of activities by the processors.

The environment allows the processors to commence or continue execution of any activity simultaneously with the movement of software-route data between the memory spaces of the processors without any involvement from software. The activity running on the processor may be completely unrelated to any of the software-routes supported by the route-table, or may even be one executing an associated software-route access procedure on a different software-route to the software-route whose data is being moved. Hence, the route-table effectively decouples in time, the movement of data by the message-passing electronics from the execution of the activities and any of their associated software-route access procedures that are running on the processors. In addition, the movement of data for a set of concurrent software-routes between activity pairs is being efficiently multiplexed onto the message-passing electronics that can only deal with data for a maximum of two software-routes at any time (one in each direction).

The environment provides a means to support a rich set of shared memory software-interaction protocols between tasks, in a distributed processing environment. Shared memory interactions allow for ‘passive’ data retention between interacting tasks and allows independent and concurrent operation of tasks, whilst enforcing synchronisation only to the minimum extent required by a particular software interaction protocol. A shared memory interaction involves some form of data item storage which removes the tight synchronisation required by shared process interactions associated with conventional computer architectures which always imposes synchronisation between tasks because data can only ‘exist’ within a process. The route-table allows the sending and receiving message passing electronics to be utilised transparently within a ‘shared memory’ interaction between software tasks. The message passing electronics effectively operates as an agent for the software task that is producing information, by writing data into remote shared memory. The protocol is implemented such that the electronics is always able to send and deliver messages without the need for message handling software. The single-bit shared variables and multi-slot mechanisms in the route-tables are accessed directly by the access procedures of the tasks, only when necessary to realise a particular software route protocol.

The route-table preferably includes a separate set of variables for each software-route supported. Hence, the movement of data associated with each supported software-route can be effected without the need for any interruption to the activities that are executing on the processors.

The programmable route-table held variables for each end of a software-route preferably includes software-route data item location, software-route data item length and identification of the software activity to which the software-route end is connected. The data item location preferably comprises the address in processor memory of one or more slots that a software-route data item is to be read from or written to. Each software-route protocol is preferably associated with multiple slots to enable concurrency of execution of activities running on different processors. Preferably, a four-slot mechanism is operative to ensure that the concurrent reading of a data item during the execution of a software-route read access procedure and the writing of a data item by the message-passing electronics are directed to different slots. This will ensure that the read access procedure can never read a data item composed of partial written data items, whilst allowing unrestricted concurrent operation. Expressed in another way, the four-slot mechanism provides protection when the hardware is servicing the same software-route that is being accessed by the read access procedure associated with the particular activity that is running on the processor at that time.

The route-table preferably includes single-bit control variables that are dynamically updated during the execution of a software-route read access procedure or a software-route write access procedure. In addition, the route-table preferably also includes single-bit control variables that are dynamically updated by the message-passing electronics. Some bits whose values are changed by the software-route access procedures are preferably also visible to the message-passing electronics and some bits whose values are changed by the message-passing electronics are preferably also visible to the software-route access procedures. These bits are called shared variables. The use of single bits removes the need to synchronise between whatever is changing the value and whatever is observing the value. The individual bit values of the shared variables are visible directly to both the software-route access procedure and the message-passing electronics, making it possible to operate reliably without the need for any form of synchronisation. This allows the route-table to be freely used between a processor and a message-passing system that are operating in different clock domains.

The values of particular control variables are preferably updated during a post-write sequence to indicate that a new data item has been added to memory and to identify the slot in memory that should be used for delivery of the next data item received on this particular software-route by the receive process of the message passing electronics. In addition, the values of other control variables are advantageously updated during a pre-read sequence by a software-route read access procedure to indicate the slot in memory that should be read.

A pre-selection process is preferably used for accessing the variables for a particular software-route. Pre-selection is used firstly, to allow for concurrent operations on multiple software-routes as explained and in addition, to reduce the complexity of individual software instructions. This reduced complexity, together with the clock-free circuitry removes the need for meeting demanding timing conditions in the electronic circuits.

In a preferred embodiment, the processing environment includes scheduling means arranged to select activities for execution according to a predefined priority scheme and may be arranged to de-schedule execution of an activity that is temporally blocked by a software-route protocol. The scheduling means is preferably arranged to associate each software-route end with a stim-wait channel for the particular activity to which the software route is connected. This arrangement advantageously provides an execution environment that allows activities that are blocked by a software-route protocol, to be deactivated from executing on the processor and reactivated some time later when the blocking condition has gone, whilst avoiding the complexity and temporal disruption caused by the operating system having to manage message passing and the associated interrupt handlers that are necessary in conventional systems.

The route-table means comprises an integrated circuit, the circuit diagram of which is preferably defined by a series of interconnected design tiles, the design tiles being arranged in an array of rows and columns. This configuration enables the overall circuit needed for different applications to be realised by using arrays of different sizes that can all be constructed from the same few simple design tile types.

Each row of the array advantageously holds the variables associated with the message-passing electronics send process of a first software-route and the message-passing electronics receive process of a second software-route. The array is designed to allow unrestricted access to the variable values for each software-route end, from two different sources; the thread of execution of a software-route access procedure, and (ii) the send or receive process of the message-passing electronics. There is no need to synchronise operation of the two sources because the design supports true independent concurrent interactions. The route table configuration enables one row to be pre-selected by the software, whilst another row has been pre-selected by the send message hardware process, whilst a further row has been pre-selected by the receive message hardware process. In other words, the message passing send and receive electronics can each be servicing a different software-route to the software-route associated with the current activity that is executing on the processor.

A separate route-table is provided at each interface between a processor and its connection point to the network of message-passing elements. The send and receive processes of the message-passing electronics each have direct access to the memory of the processor to insert or retrieve software-route data items. The environment of the present invention can hence be applied to complex multiple-processor systems by allowing a particular message-passing path (bus or link) to support a set of the software-routes, between pairs of interacting activities executing in different processors, without the need for a complex operating system.

Interface means may be provided to allow interaction between the route-table and the software-route access procedures associated with activities running on the processors and also to allow interaction between the route-table and the associated message-passing elements. The interface means between the route-table and software-route access procedures advantageously includes circuitry arranged to pre-select the route-table row that holds the control variables for a particular software-route. The interface means between the route-table and the message-passing electronics receive process also advantageously includes circuitry arranged to pre-select the route-table row that holds the control variables for a particular software-route. The route-table itself also advantageously includes circuitry arranged to pre-select the route-table row for the message-passing electronics send process that holds the control variables for a particular software-route. Since at any one time, all three pre-selected rows may be different, unrestricted concurrent operation is enabled. A software pre-selected row can be the same or different to the message-passing electronics pre-selected row. Pre-selection by a software access procedure and the message-passing electronics may overlap in any way, to allow for the processor to be executing one software-activity whilst the message-passing electronics is moving the data associated with an unrelated software-route.

From a second aspect, the present invention resides in a method of transferring software-route data between interacting activities being executed on different processors in a real-time distributed processing environment comprising holding variables for each software-route supported by the message-passing elements between the processors; presenting variables for a read access procedure associated with an activity of a first software-route to the message-passing elements; presenting variables for a write access procedure associated with an activity of a second software-route to the message-passing elements; transferring the software-route data item associated with the read access procedure of first software-route and the write access procedure of the second software-route; and executing an activity on either or both processors, wherein the transfer of data and the execution of the activity are concurrent.

The method facilitates the presentation of variable values that will support the distribution for two software-routes in a distributed processing environment using ‘send’ and a ‘receive’ processes of the message-passing electronics, which are then able to transfer the data item for the particular route, using Direct Memory Access (DMA) to extract and insert data from the memory of each processor without any involvement from software. This allows the processors to commence or continue execution of any activity simultaneously with the movement of software-route data between their memory spaces. At any particular time, the activity running on the processor may be completely unrelated to any of the software-routes supported by the route-table, or may even be one executing a route-table access procedure on a different software-route to the software-route whose data is being moved. This effectively decouples in time, the movement of data by the message-passing electronics from the execution of the activities and their software-route access procedures, running on the processors. Moreover, the movement of data for a set of concurrent software-routes between activity pairs is being efficiently multiplexed onto the message-passing electronics that can only deal with data for a maximum of two software-routes (one in each direction) at any one time.

Some of the variables are preferably updated by the message-passing elements during a post-write sequence to indicate that a new data item has been added to memory and to identify the slot in memory to be used for delivery of the next data item received on the software-route by the message-passing electronics. In addition, the values of some control variables are preferably updated during a pre-read sequence by a software-route read access procedure to indicate the slot in memory that should be read

In a preferred embodiment, activities are scheduled for execution according to a predefined priority scheme. In addition, execution of a scheduled activity that is temporally blocked by a software-route protocol may be de-scheduled.

An embodiment of the invention will now be described by way of example with reference to the accompanying drawings in which:

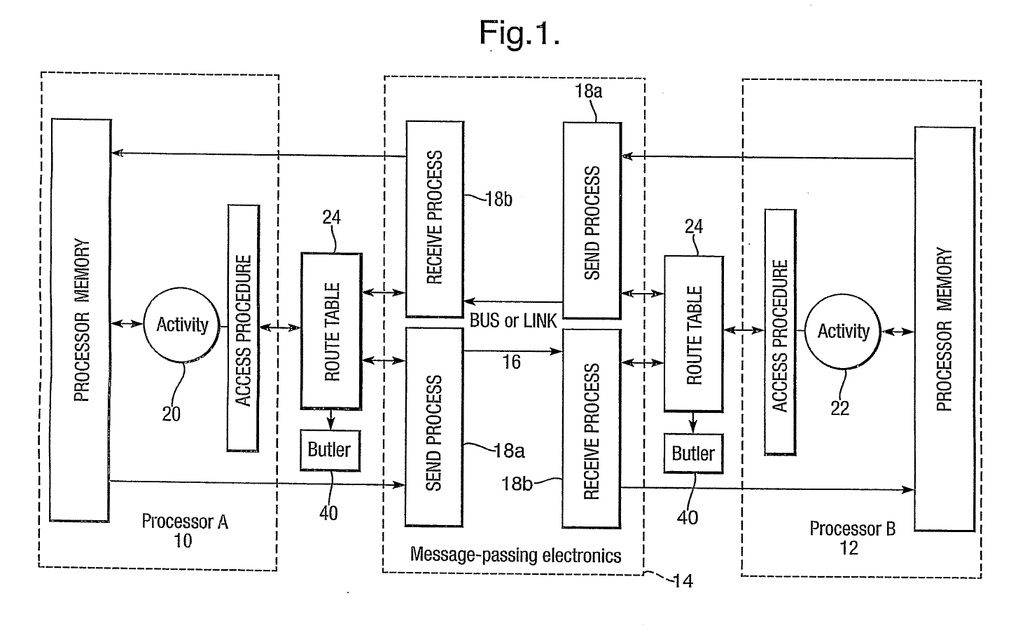

FIG. 1 is a simplified schematic representation of a real-time distributed processing environment according to a preferred embodiment of the present invention;

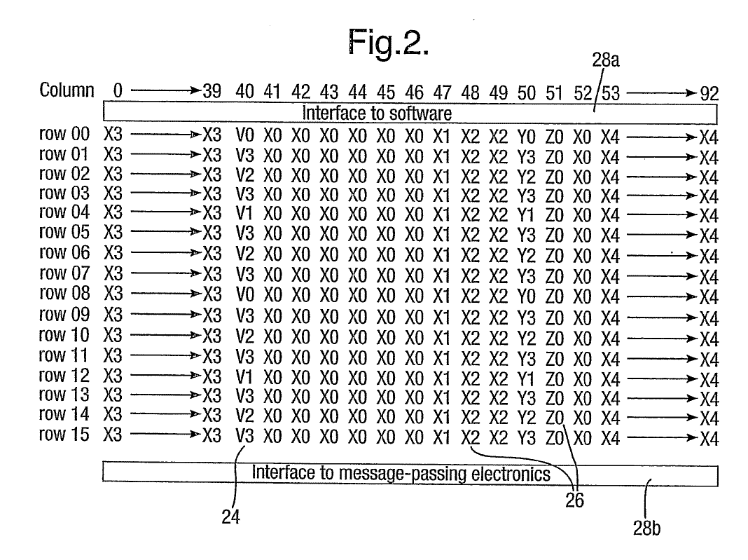

FIG. 2 illustrates the configuration of the various design tiles making up a route-table array used in the real-time distributed processing environment of FIG. 1;

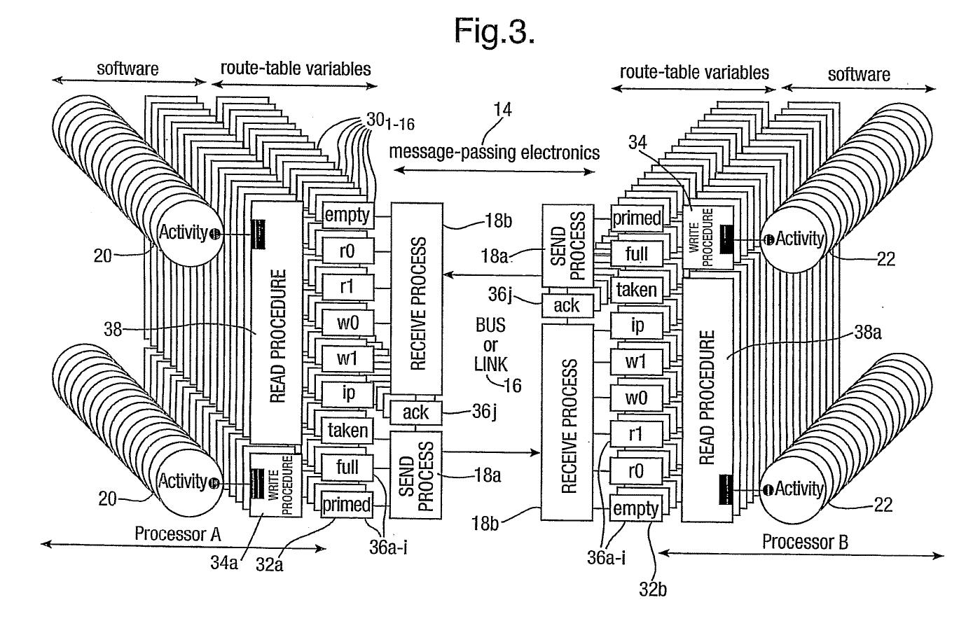

FIG. 3 is an alternative representation of the route-table array configuration shown in the context of the real-time distributed processing environment of FIG. 1;

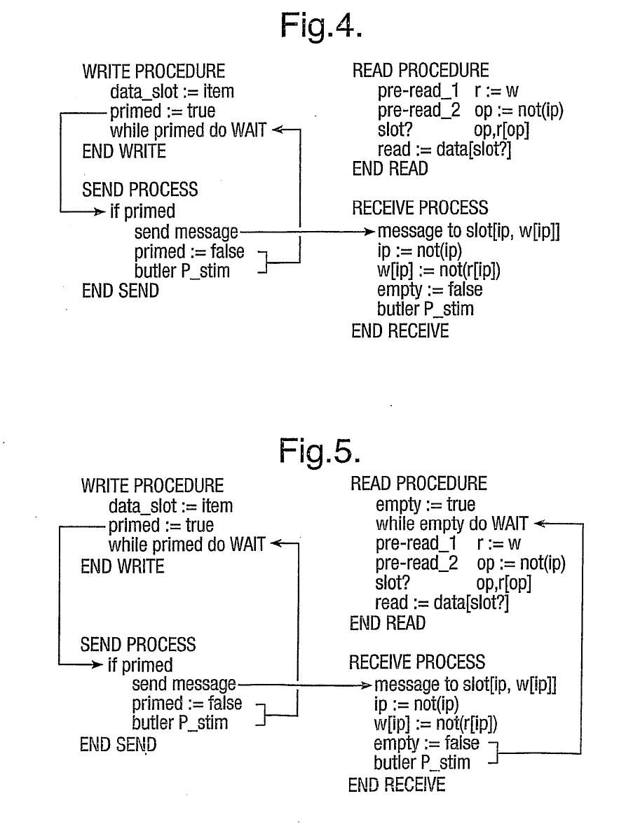

FIG. 4 is a representation of a protocol for a closed-loop software-route of the type POOL used in the real-time distributed processing environment of FIG. 1;

FIG. 5 is a representation of a Flash Data protocol for a closed-loop software-route of the type SIGNAL used in the real-time distributed processing environment of FIG. 1;

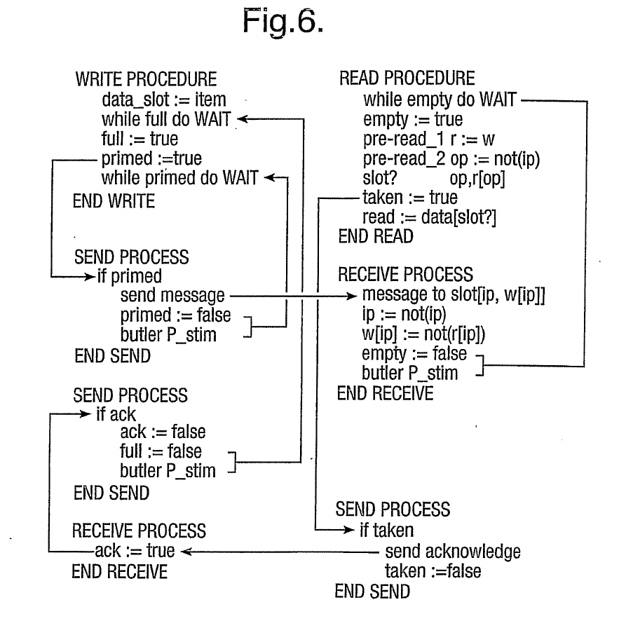

FIG. 6 is a representation of a protocol for a closed-loop software-route of the type CHANNEL used in the real-time distributed processing environment of FIG. 1;

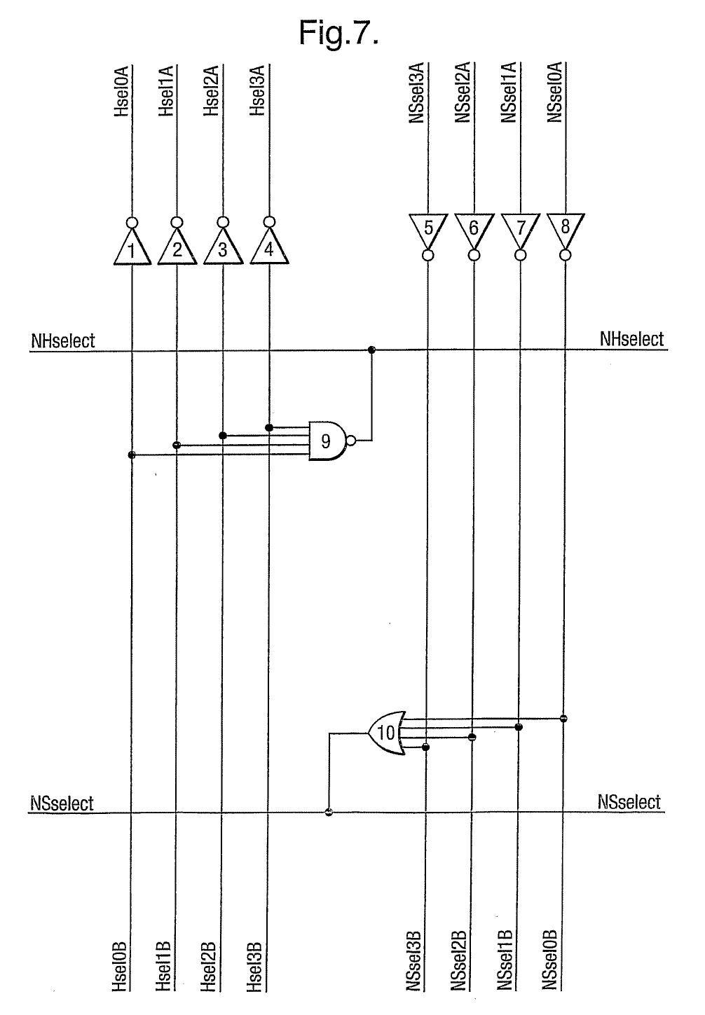

FIG. 7 is a logic circuit diagram of a Type V design tile used in the route-table array shown in FIG. 2;

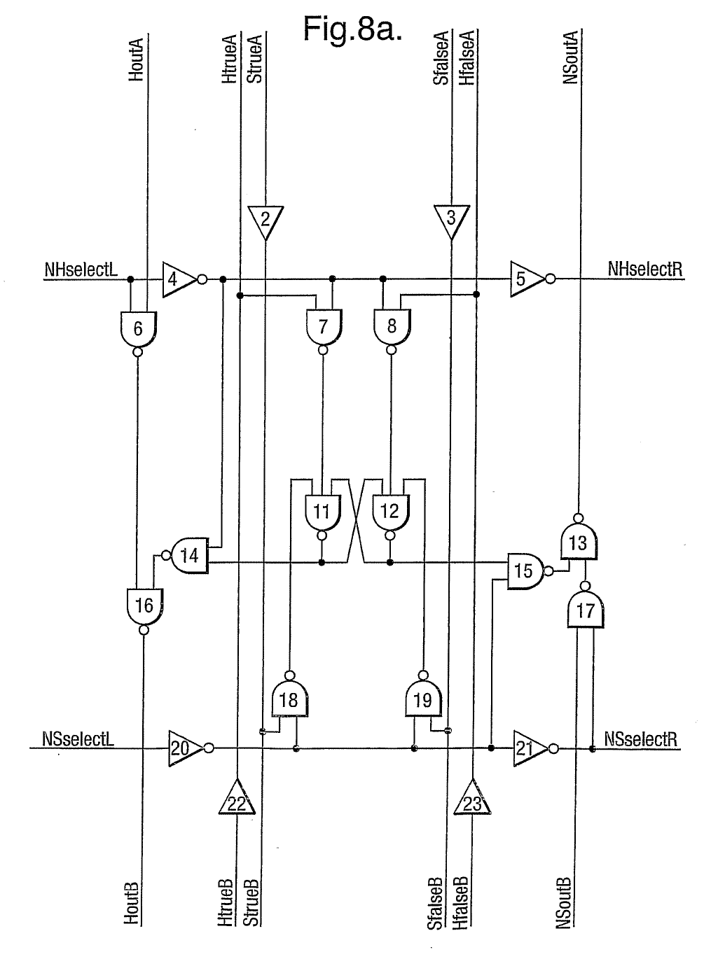

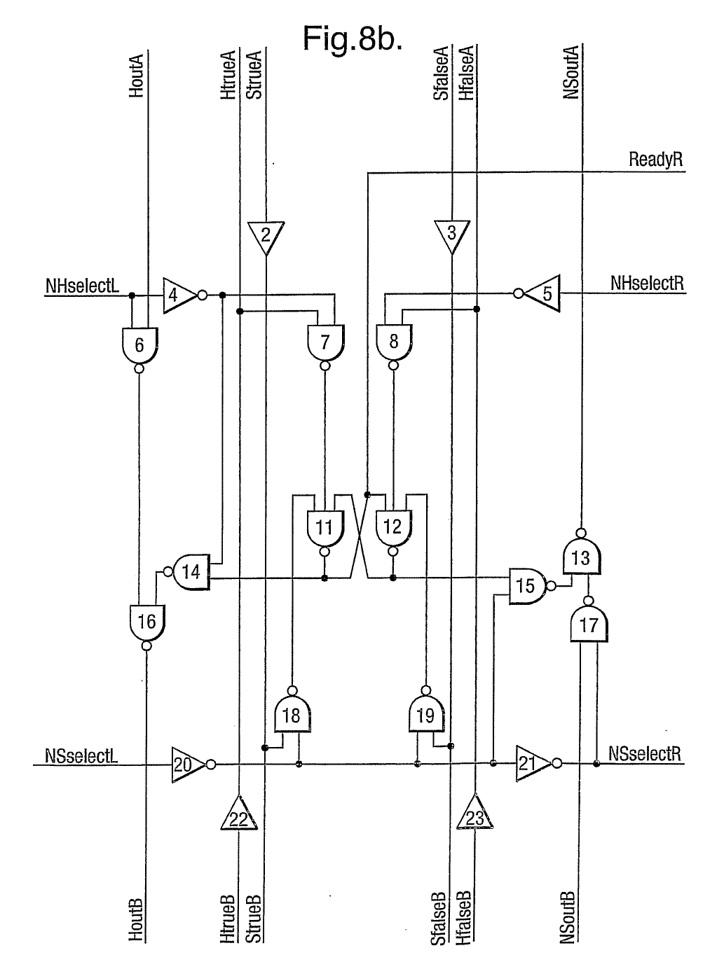

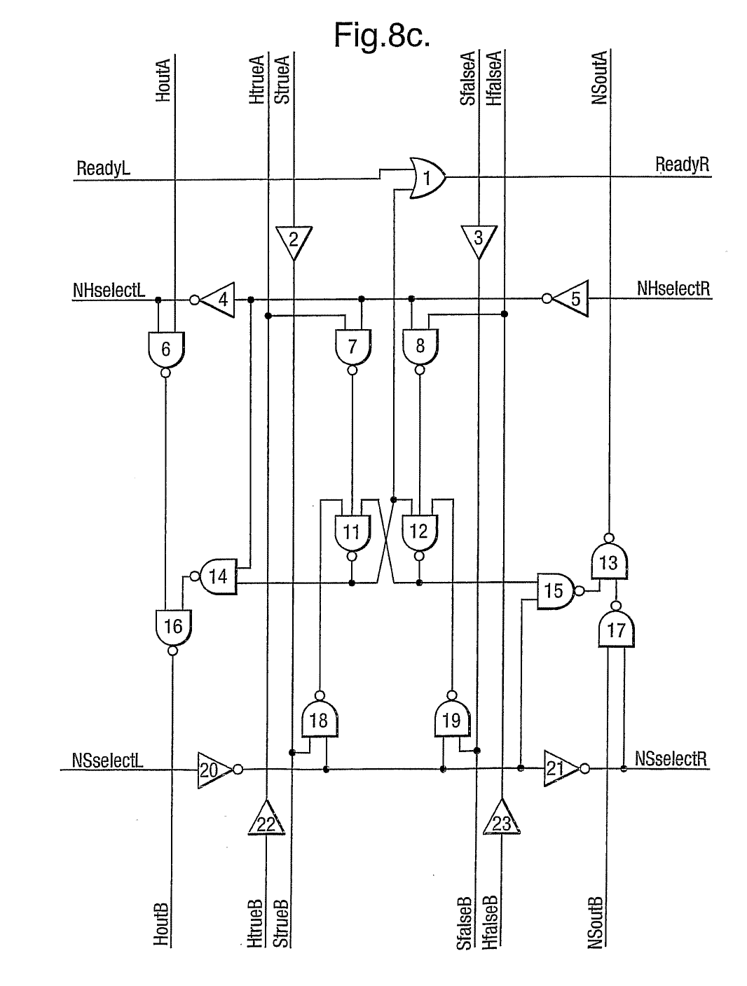

FIGS. 8a, 8b, 8c are logic circuit diagrams of three different versions (X0, X1 and X2) of a Type X design tile used in the route-table array shown in FIG. 2;

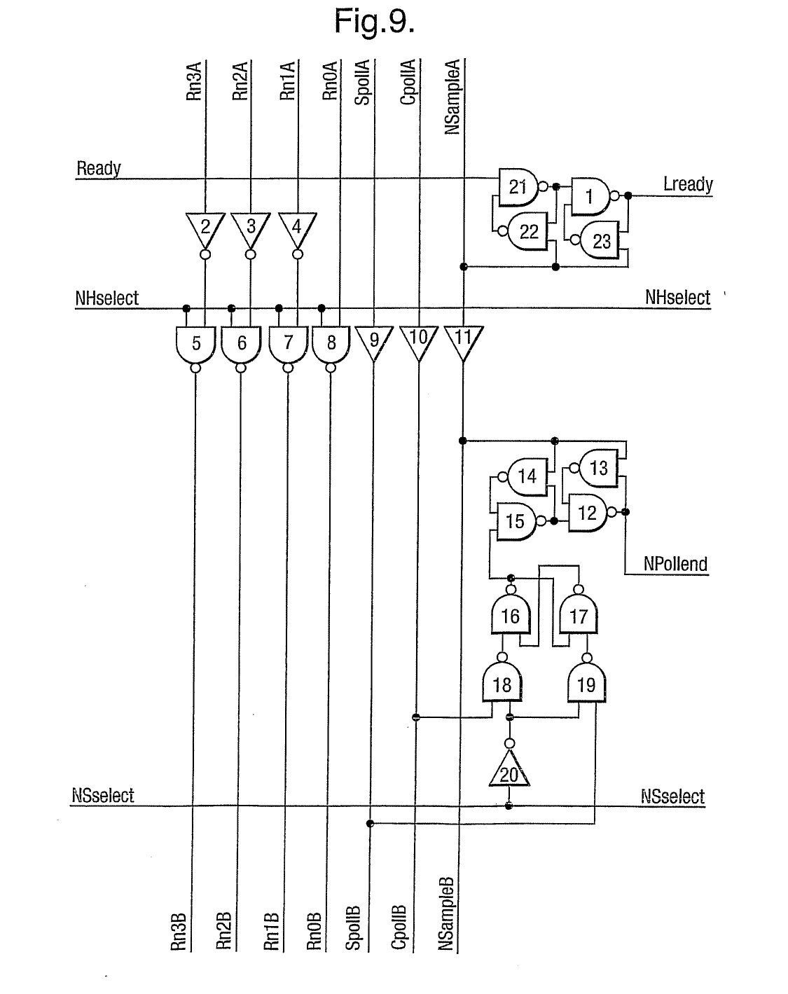

FIG. 9 is a logic circuit diagram of a Type Y design tile used in the route-table array shown in FIG. 2;

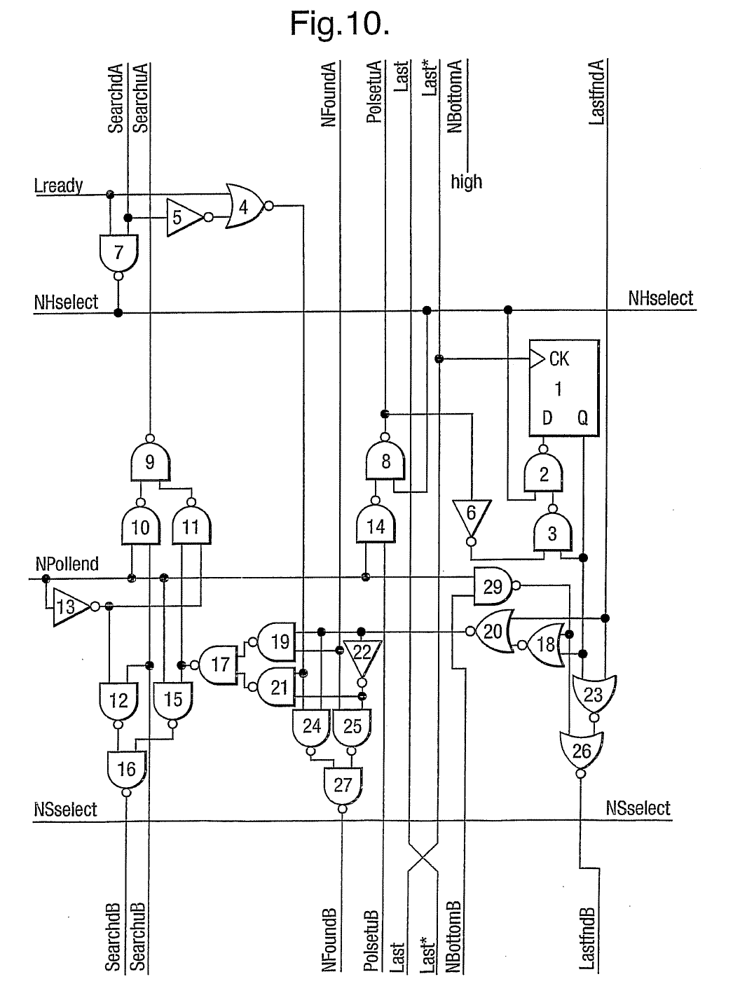

FIG. 10 is a logic circuit diagram of a Type Z design tile used in the route-table array shown in FIG. 2;

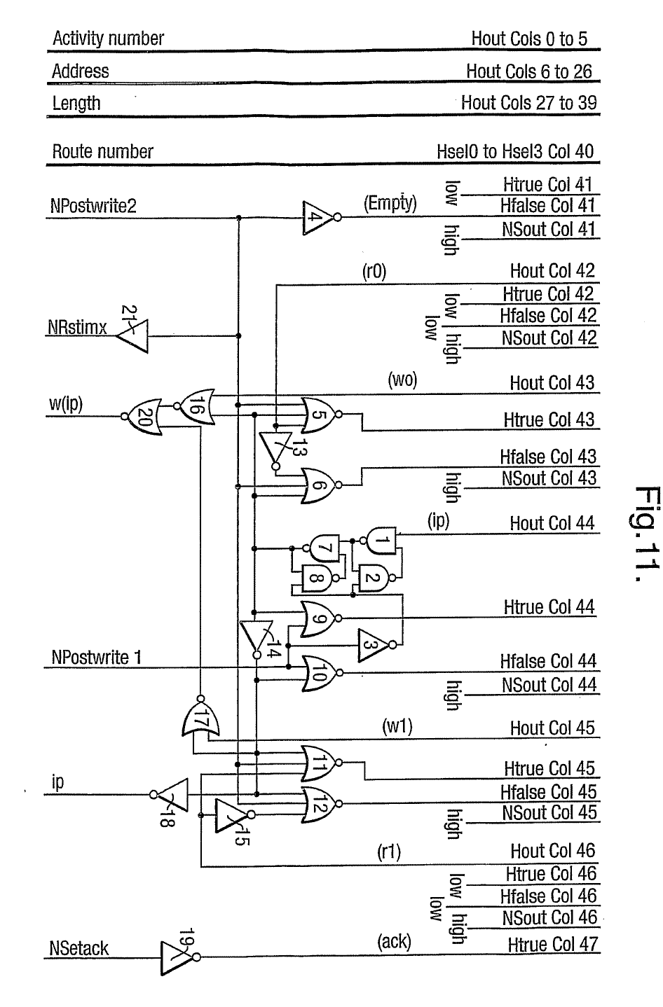

FIG. 11 is a logic circuit diagram of the interface between the route-table array and the associated message-passing receive process electronics of the real-time distributed processing environment of FIG. 1;

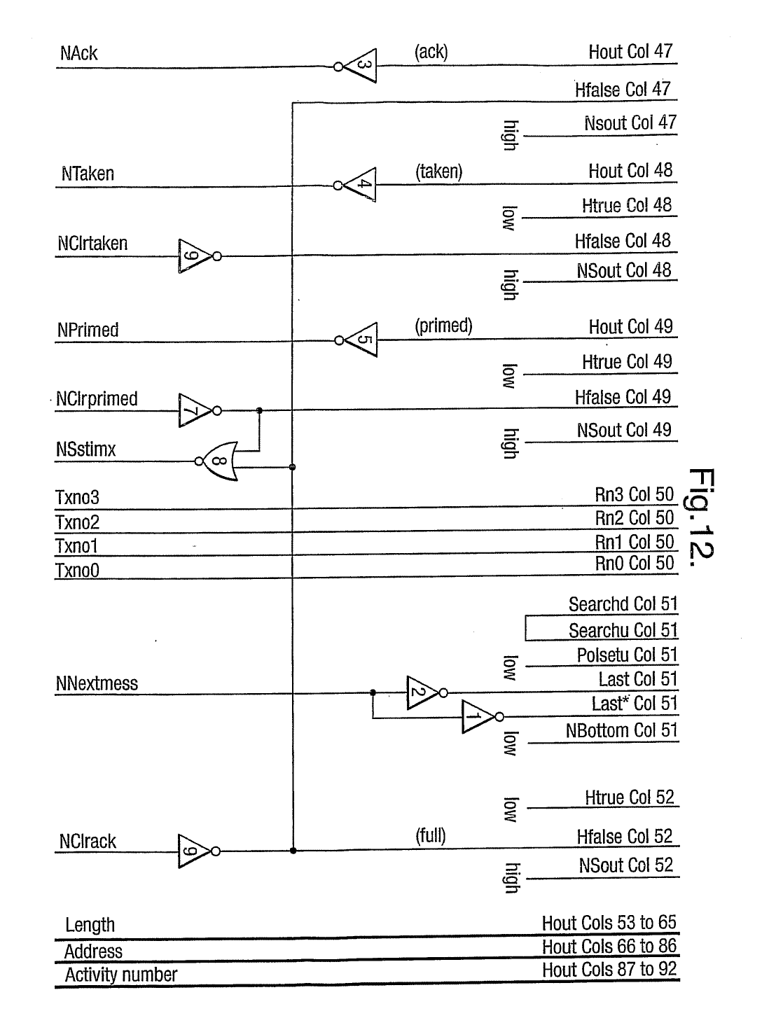

FIG. 12 is logic circuit diagram of the interface between the route-table array and the associated message-passing send process electronics of the real-time distributed processing environment of FIG. 1;

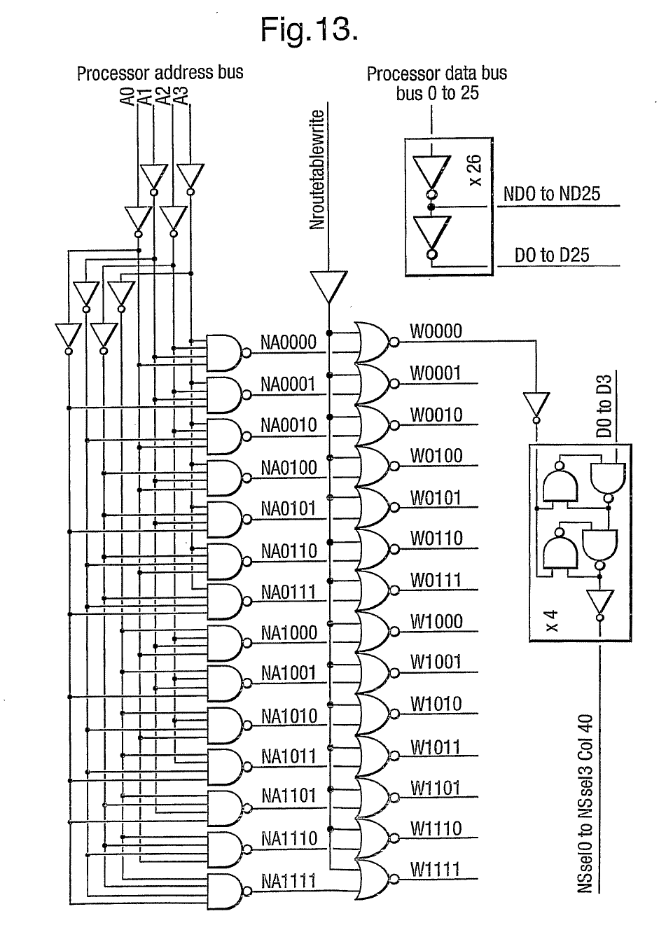

FIG. 13 is a logic circuit diagram of part of a memory-mapped processor interface between the route-table array and the software illustrating the processor bus address decode logic, route-table write strobe pulse generation logic, processor data bus buffers and the logic used for pre-selection of a row;

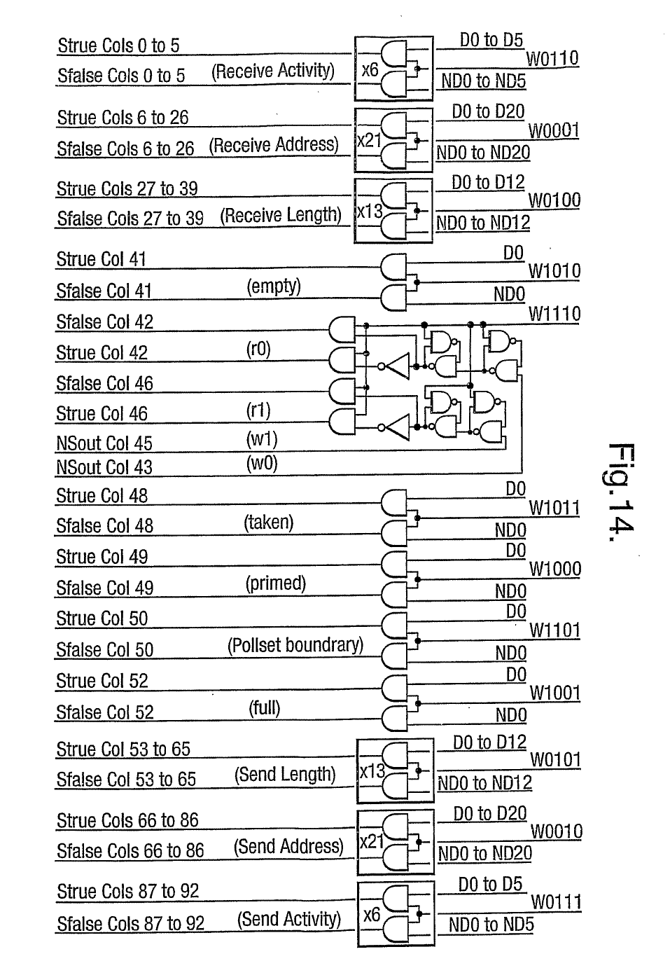

FIG. 14 is a logic circuit diagram of another part of the memory-mapped processor interface between the route-table array and the software illustrating the pulse gating logic used for writing particular variable values to a pre-selected route-table array row; and

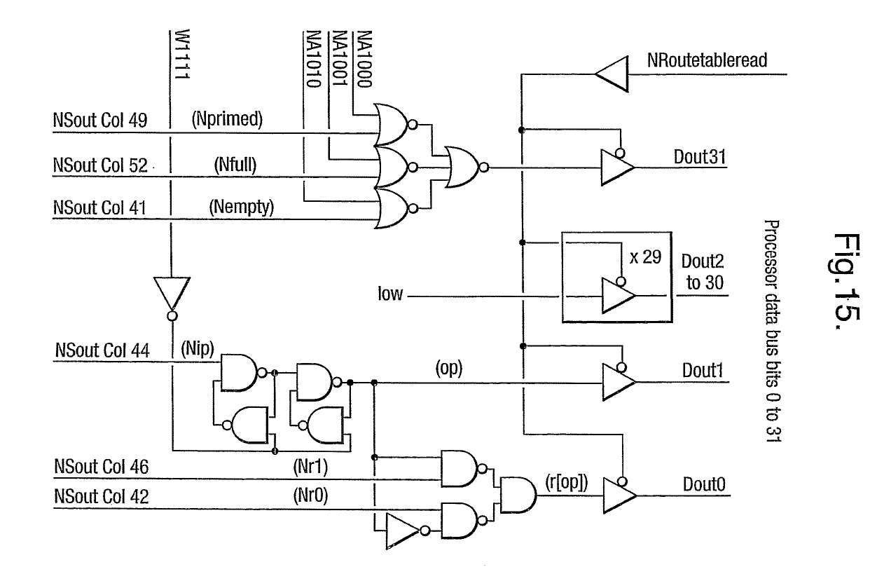

FIG. 15 is a logic circuit diagram of another part of the memory-mapped processor interface between the route-table array and the software illustrating the logic used for reading variable values from a pre-selected route-table array row.

Firstly, for a better understanding of the invention, a short description of the system level dynamic characteristics for each of the three families of ROUTE communication protocols (Signal, Channel and Pool) supported by the real-time distributed processing environment of the present invention will now be given.

The Signal type of software-route protocol allows event data to be passed from one activity to another. It is characterized by a destructive read operation and a destructive write operation. An activity attempting to read from an empty signal will be blocked until data is available. If the reading activity is deactivated when blocked, then writing to a signal involves a stimulus that can reactivate a blocked reading activity. Writing to a signal protocol is never blocked and so may overwrite an item in a full buffer (destructive write action).

The Channel type of software-route allows message data to be passed from one activity to another and is used when the reader must obtain in sequence every item written. It is characterized by a destructive read operation and a non-destructive write operation. In the Channel, once the reader has read an item, it does not remain in the Channel (destructive read operation). Writing to a channel adds an item without overwriting any items already in it (non-destructive write operation). A Channel can become empty and because its capacity is finite, it can become full. If the reading activity is deactivated when blocked because the Channel is empty, then writing to a channel involves a stimulus that can reactivate a blocked reading activity. If the writing activity is deactivated when blocked because the Channel is full, then reading from a channel involves a stimulus that can reactivate a blocked writing activity.

The Pool type of software-route protocol allows reference data to be passed from one activity to another and is used when the reader should obtain the most recent item written. It is characterized by a non-destructive read operation and a destructive write operation. Reference data is retained within the pool where it can be consulted at any time by the reader and updated at any time by the writer. Repeated reader accesses to a Pool will provide the same item (non-destructive read operation), until the writer has produced a new data item, but as soon as this new item is available, the previous data is no longer valid (destructive write operation).

The Pool protocol does not imply, require or provide any synchronism between the writer and the reader, whereas the Channel protocol synchronizes the writer and the reader to the extent that it does not allow the writer to proceed when the channel is full, or the reader to proceed when the channel is empty.

In a Signal, Channel or Pool software-route protocol, the data that is to be passed between the writer and the reader is held in some form of memory. As described earlier, the amount of memory required to hold one complete data item is called a slot. The protocol designs enable concurrent operation of the writer and reader by including more than one slot. For example, a channel protocol design may use three slots: one to allow the writer to be assembling a new data item; whilst one is holding the most recently written data item; whilst one is allowing the reader to still be accessing the previous data item.

Referring now to FIG. 1, which shows a simple distributed processing environment comprising two distributed processors A (10) and B (12) interconnected by message-passing electronics (14) comprising a bus or link (16) and a send (18a) and a receive process (18b) at each end of the link (16) to allow data items to be moved between the processors (10, 12). A software-route exists between an activity (20) that is assigned to run on processor A (10) and an activity (22) that is assigned to execute on processor B (12). However, it should be understood that activities (20) and (22) may also be de-scheduled and not actually running at any point in time. This interaction may involve the message-passing electronics (14) in the sending of a software-route data item to processor B (send process) (18a) or the receiving a software-route data item from processor B (receive process) (18b). At the interface between processor A (10) and the message passing electronics send and receive processes (18a) and (18b), there is provided a route-table (24) that serves to facilitate the transfer of a software-route data item over the bus or link (16). The route-table (24) holds programmable information for a set of software-routes that are to be supported by that particular bus or link (16), together with the shared variables and logic that will realise the required interaction protocol for each software route that is supported, and a collection of control variables as will described in more detail below.

Conceptually, the route-table (24) can be expressed as a modular design structure, comprising an overall electronic circuit defined by a set of interconnected design tiles (26) arranged in rows (00-15) and columns (00-92) to form a two dimensional array as is shown in FIG. 2. Each tile (26) of the array defines a part of the overall electronic circuit, expressed as a block having logic, structure and connections. All necessary signal connections between the circuitry in the tiles (26) are on the touching edges between adjacent design tiles, with no additional inter-tile signal routing being required to complete the circuit. There are four basic design tile types (26) included in the route-table of the described embodiment shown in FIG. 2, represented by the letters V, X, Y and Z, each tile (26) comprising a plurality of interconnected logic gates and input/output connections for interfacing with adjacent tiles. The structure and functionality of the different types of design tiles (26) will be described in more detail below.

The route-table array shown in FIG. 2 has sixteen rows, each holding the configuration data and control variables for two different software-routes, the sending end for one software-route and the receiving end for another software-route as will be described in more detail. Row 00 is associated with incoming route number zero and outgoing route number zero, with route numbers incrementing for each row down the array. As will be described in more detail later, the route-table (24) also comprises an interface (28a) from a software-route access procedure at the top of the array, and an interface (28b) from message-passing electronics (16) at the bottom of the array.

An alternative representation of the route-table array concept is illustrated by the “stacked” arrangement shown in FIG. 3, where each layer (301-16) of the “stack” represents two different software-routes (32a, 32b), each between a pair of activities (20, 22) that have been assigned to execute on different processors A (10) and B (12). Each individual software-route (32a, 32b) has its own software-route write access procedure (34), a set of ten route-table held variables (36a-36j) and a software-route read access procedure (38). However, all of the software-routes share the single message-passing electronics (14), which comprises a bus or link (16) and a send and a receive process (18a, 18b) at each end of the link (16). The overall array (24) is designed to hold the variables for the entire set of software routes that are to be supported by the bus or link (16) of the present embodiment, each individual row holding the variables for two software-route ends. One software-route end is used by the message-passing electronics receive process (18b) and is associated with a software-route read access procedure (38) while the other software-route end is used by the message-passing electronics send process (18a) and is associated with a software-route write access procedure (34).

It should be understood that the route-table array (24) could comprise any appropriate number of rows depending on the number of routes to be supported by the associated message-passing electronics (14). In addition, the number of columns to hold data item location, length and associated activity number for both send and receive can be tailored as well according to the requirements of a specific application. This configuration enables the overall circuit needed for different applications to be realised by using arrays of different sizes that can all be constructed from the same few simple design tile types.

The array (24) is designed to allow unrestricted access to the variable values from three different sources; (i) the thread of execution of the software-route access procedure associated with a particular activity (20, 22) assigned to run on the processor (10, 12) to which a route-table (24) is directly connected, (ii) the send process (18a) of the message-passing electronics (14) and (iii) the receive process (18b) of the message-passing electronics (14). Of course, it should be understood that unrestricted access to the variable values by a thread of execution of a software-route access procedure can only occur when execution is actually taking place. The four-slot mechanism variables for each software-route are shared between the thread of execution of the software-route read access procedure (38) associated with activity (20) running on the local processor A (10) and the receive process (18b) of the message-passing electronics 14, which is effectively acting as an agent for the thread of execution for the software-route write access procedure (34) associated with activity (22) assigned to run on the remote processor B (12). Each software-route protocol includes some single-bit shared variables that reside in the interaction component between the threads of execution of a pair of interacting activities (20, 22) assigned to run on the distributed processors A (10) and B (12).

A pre-selection technique may be used for accessing the variables for a particular software-route as will be described in more detail later. Pre-selection is used firstly, to allow for concurrent operations on multiple software-routes as explained and in addition, to reduce the complexity of individual software instructions. This reduced complexity, together with the clock-free circuitry removes the need for meeting demanding timing conditions in the electronic circuits.

The software-route protocol designs support the interactions that can occur when two independent threads of execution are concurrently executing on different processors (10, 12). As will now be described, the relevant software-route information is made available, at the appropriate time, to the message handling electronics (14) and other circuits. In addition, signals from the message-passing electronics (14) to the route-table (24) are used to dynamically update the control variable values (34a-34j) as is described in more detail below.

Although the route-table (24) holds the current variable values for the entire set of software-routes supported by the associated message-passing electronics (14), at any one time, only the data associated with a maximum of two software-routes (one in each direction) can be moved across the bus or link (16). Therefore, the route-table (24) presents the variable values for one particular software-route at a time required by the ‘send’ process (18a) of the message-passing electronics (14). The send process (18a) is then able to send the data for the particular route across the bus or link (16), using Direct Memory Access (DMA) to extract data from the memory of processor A (10) without any involvement from software. At the same time, the route-table (24) may also present the variable values for another software-route to the receive process (18b) of the message-passing electronics (14), which is able to insert data into the memory of processor A (10) memory using DMA, again without any involvement from software. This allows processor A (10) to commence or continue execution of any activity simultaneously with the movement of software-route data between the memory spaces of processors A and B (10, 12) by the message-passing electronics (14). The activity running on the processor (10, 12) may be completely unrelated to any of the software-routes supported by the route-table (24), or may even be one executing a route-table access procedure on a different software-route to the software-routes whose data may be being moved at that time.

The route-table (24) includes single-bit control variables (36a-36j) that are dynamically updated by software access procedures (34, 38) and by the message-passing electronics (14). Some bits whose values are changed by the software-route access procedures (34, 38) are preferably also visible to the message-passing electronics (14) and some bits whose values are changed by the message-passing electronics (14) are preferably also visible to the software-route access procedures (34, 38). The use of single bits removes the need to synchronise between whatever is changing the value and whatever is observing the value. If observed when stable the observer will see a clean ‘true’ or ‘false’ value. If observed when changing the observer may not get a clean ‘true’ or ‘false’ value until a metastable state has been resolved. However, in this case it does not matter whether a ‘true’ or a ‘false’ value is used because there are only two possibilities; it will either be the pre-change value or the updated value and our mechanisms will work correctly with either. These bits are the ‘shared-variables’. Their individual bit values are visible directly to both the software-route access procedure (34, 38) and the message-passing electronics (14). It is the use of these single-bit shared variables that makes it possible to operate reliably without the need for any form of synchronisation. This allows the route-table (24) to be freely used between a processor (10, 12) and a message-passing system (14) that are operating in different clock domains.

Although the embodiment of the invention illustrated in FIGS. 1 to 3 has been described in the context of a software-route writing or reading access procedure (34, 38) for each software-route end supported by the route-table (24) associated with processor A (10), and the send and receive processes (18a, 18b) of the message-passing electronics (14) at processor A (10), it should be understood that these will necessarily involve the send and receive processes of the message-passing electronics (18a, 18b) at processor B (12). For example, the send process (18a) at processor A (10) will involve a receipt of software-route data item over the bus or link (16) to be inserted into the memory at processor B (12). Similarly, the receive process (18b) at processor A (10) will have involved the sending of software-route data item from processor B (12) over the bus or link (16).

A Butler style task scheduler (40) (shown in FIG. 1) of the type described in WO 97/22926 selects activities to run on the processors (10, 12) according to some defined priority scheme but will automatically exclude scheduling activities at times when they are temporally blocked by a software-route protocol. Hence, the route-table (24) effectively decouples in time, the movement of data by the message-passing electronics (14) from the execution of the activities (20, 22) and their associated software-route access procedures (34, 38), running on the processors.

In addition, since the route-table (24) holds a separate set of variable values for each software-route supported and, since each activity on a processor (10, 12) can initiate execution of its software-route reading or writing access (34, 38) procedure at any time, the movement of data for a set of concurrent software-routes between activity pairs (20, 22) is being efficiently multiplexed onto the message-passing electronics (14) that itself can only deal with data for a maximum of two software-routes at any one time.

The values of the single-bit control variables used in the four-slot mechanism located at the receiving end of each software-route are changed by operations in the post-write and pre-read sequences when data items are inserted or inspected in memory. The protocol multiple-slots are at the software-route read access (38) procedure end. The post-write sequence is executed by the message-passing electronics (14) at the receiving end following insertion of a data item into the slot identified by the route-table held shared-variables. The software writing activity (34), which is associated with the route-table sending end, always assembles its data item into a local slot, and in the closed-loop protocol forms described, waits (and is de-scheduled to allow other activities to execute) until the data item has been transferred and inserted, on the writers behalf, into the relevant software-route protocol slot, which is at the receiving end. The post-write sequence initiated by the receive process message-passing electronics (18b), updates the control variable values to indicate that a new data item has been added and to identify which slot should be used when delivering the next data item received for this particular software-route. The pre-read sequence carried out by the software-route read access procedure updates the control variables to indicate the slot that should be read from and to protect it from being over-written by a subsequent data item insertion by the message-passing receive process.

It should be understood that an individual route-table (24) is used at each connection point to message-passing electronics (14) within the distributed multiprocessor system and is designed to hold programmable information for the set of software-route ends terminating at that connection point. It holds programmable information that identifies the data item location, the data item length the activity number of the activity that is connected to the software-route end and a set of software-route variable values for each software-route supported.

Any row in the array of the route-table (24) may be assigned to, and pre-selected for use by a software-route access procedure associated with activity (20) running on the processor A (10), at the same time that any row in the route-table array (24) is pre-selected for use by the send process (18a) of the message-passing electronics (14), and any row is selected by the receive process (18b) of the message-passing electronics (14). The software-route access procedure (34, 38) pre-selected row can be the same or different to the message-passing electronics send and receive processes (18a, 18b) pre-selected rows. Pre-selection by the software-route access procedure (34, 38) and message-passing electronics (18a, 18b) may overlap in any way, to allow for the processor A (10) to be executing an access procedure for one activity (20) whilst the send process (18a) and the receive process (18b) of the message-passing electronics (14) are operating with the bus or link (16) in moving the data associated with two unrelated software-routes.

As is illustrated in FIG. 2 and described in more detail below, the interface (28a) to the software-route variables from a software-route access procedure (34, 38) is conceptually at the top of the array, and the interface (28b) to the software-route variables from message-passing electronics (14) is conceptually at the bottom of the array. The route-table (24) can be used in conjunction with the Butler chip (40) described in WO 97/22926 to provide an execution environment that allows activities that are blocked by a software-route protocol, to be deactivated from executing on the processor (10, 12) and reactivated some time later when the blocking condition has gone, whilst avoiding the complexity and temporal disruption caused by the operating system having to manage message passing and the associated interrupt handlers that are necessary in conventional systems. It allows data-item length, location and associated activity number values, to be written once when initializing a software-route and thereafter to be independently accessed by the message-passing electronics (14) each time a data item is transferred on that particular software-route. This avoids the need for the software-route access procedure (34, 38) to rewrite this information every time a data item is inserted or retrieved on the software-route.

As described above, each time the message-passing electronics (14) is ready to send a message, the route-table (24) makes available the set of variables for one particular outgoing software-route end, via the message-passing electronics interface (28b) (described later in this specification). The send process (18a), expressed by the following algorithm, is executed by the message-passing electronics (14), each time a message (software-route data item) is sent:

Loop:

Next-message

if ack

ack := false // full := false // stim_butler

else_if taken

send acknowledge message
taken := false

else_if primed

send message
primed := false // stim_butler

end_if

jump Loop

End:

Next-message is an input to the route-table (24) from the message-passing electronics send process (18a) indicating that it is free to send a message. The route-table (24) responds by making available the variable values for the next message that should be sent. These variables include the route-table array row number that identifies the software-route number, which the send process (18a) includes in a header to any message that it sends.

Each time the message-passing electronics receive process (18b) receives an incoming message from the bus or link (16), it extracts the route-table row number from the header and presents it to the route-table (24), via the route-table's message-passing electronics interface (28b) (described later in this specification). The message passing electronics interface (28b) pre-selects the corresponding row in the array to make available the set of variables for the software route relating to the incoming message. The receive process (18b), expressed by the following algorithm, is executed by the message-passing electronics (14), each time a message (data item) is received:

Start:

receive first byte

if an acknowledge message

ack := true

else

deliver message to slot number (ip, w[ip])
ip := not(ip)
w[ip] := not(r[ip]) // empty := false // stim butler

end_if

End:

The send process (18a) and the receive process (18b) executed by the message-passing electronics (14) are not changed when supporting Signal, Channel or Pool software-route protocols. The different characteristics necessary for each software-route protocol are realised by the differences in the software-route access procedures (34, 38) that activities (20, 22) use to insert data items into, or retrieve data items from, a particular software-route.

Three examples of write and read software-route access procedures (34, 38) that interact with the route-table (24) in different ways to realise different software-route protocols, will now be described.

A closed-loop Pool software-route protocol, where a read access procedure executing in processor A (10) will obtain the most recent (freshest) data item written by a write access (34) procedure in processor B (12), is described with reference to FIG. 4. The freshest data item is retained within a slot of a four-slot mechanism in the memory of processor A (10), where it can be consulted at any time via the read access procedure (38) executing on processor A and updated at any time by the write access procedure (34) executing in processor B (12). The activity associated with the write access procedure (34) in processor B assembles the data item that is to be inserted into the pool in a slot in the memory of processor B (12), that can be accessed by the message-passing electronics ‘send’ process (18a). The write access procedure (34) indicates when the data item is ready to be sent by setting the ‘primed’ bit (36a) true in the particular row of the route-table (24) assigned to support this software-route. The write access procedure (34) then waits until the message-passing electronics ‘send’ process (18a) has sent the data item across the bus or link (16) and the message-passing electronics ‘receive’ process (18b) at processor A (10) has entered the data item into the appropriate slot in the memory of processor A (10). The message-passing electronics ‘send’ process (18a) at processor B (12) indicates that the data item has been entered into the pool located in the memory of processor A (10) by setting the ‘primed’ bit (36a) false.

The write access procedure (34) executing on processor B (12) includes a ‘while primed do WAIT’ procedure which can be used to de-schedule the associated activity (22) from running on processor B (12) until the message passing electronics (14) has written the data item into the pool located in the memory of processor A (10). An efficient way to deactivate and reactivate an activity is to use the Butler (40) described in WO 97/22926, and associate each software-route end with a stim-wait channel for the activity number to which the software-route is connected. [NOTE—this applies to the ‘do WAIT’ operations for all of the procedures described below]

The first two operations of the read access procedure (38) update variables held in the route-table (24), via the route-table's software interface (28a) described later, to execute the pre-read sequence for a four-slot mechanism. The third operation returns the slot number that contains the freshest complete data item. The four-slot mechanism ensures that the slot, identified as containing the freshest data item at this time to the activity associated with the read access procedure, will not be corrupted by subsequent insertion of data items by the message passing electronics (14). The post-write sequence for the four-slot mechanism is executed on behalf of the write access procedure (34) executing on processor B (12), by the message-passing electronics ‘receive’ process (18b) at processor A (10), each time a new data item is inserted. An embedded four-slot mechanism is being used within every software-route to allow sound independent concurrent operation of memory updates by the message-passing electronics (14) and activities (20, 22) executing on the processor.

A closed-loop Flash Data software-route protocol, which belongs to the Signal family of protocols, where a read access procedure (38) executing in processor A (10) will obtain the obtain the next data item that is written by a write access procedure (34) executing in processor B (12), is described with reference to FIG. 5. A read access procedure that starts executing in processor A (10) will disregard any pre-existing data item and will be blocked until the next data item is available. If the activity associated with the read access procedure (38) executing on processor A (10) is deactivated when blocked, then the write access procedure (34) executing on processor B (12) involves a stimulus that can reactivate a blocked activity (20) on processor A (10).

The Flash Data protocol data item is retained within a slot of a four-slot mechanism located at the memory of processor A (10), where it can be conditionally accessed by a read access procedure (38) executing on processor A (10) and updated at any time by a write access procedure (34) executing on processor B (10). The activity associated with the write access procedure (34) assembles the data item that is to be inserted into a local slot in the memory of processor B (12) that can be accessed by the message-passing electronics ‘send’ process (18a) at processor B (12). The write access procedure (34) indicates when the data item is ready to be sent by setting the ‘primed’ bit (36a) true in the particular row of the route-table (24) assigned to support this software-route. The write access procedure (34) then waits until the message-passing electronics ‘send’ process (18a) at processor B (12) has sent the data item and the message-passing electronics ‘receive’ process (18b) at processor A (10) has entered the data item into the appropriate slot in the memory of processor A (10). The message-passing electronics ‘send’ process (18a) indicates that the data item has been entered into the memory of processor A (10) by setting the route-table held ‘primed’ bit (36a) false in the route-table (24) at processor B (12).

The first operation of the read access procedure (38) sets the route-table held ‘empty’ variable (36i) true, which has the effect of disregarding any previously written data item. It then executes a ‘while empty do WAIT’ procedure which can be used to de-schedule the activity from running on the processor until the message passing electronics (14) has delivered the next data item for this particular software-route. The following two operations of the read access procedure (38) execute the pre-read sequence for a four-slot mechanism and the third operation returns the slot number that contains the new data item. A closed loop Channel software-route protocol where a read access procedure (38) executing on processor A (10) obtains in sequence every data item written by the write access procedure (34) executing on processor B (12) is now described with reference to FIG. 6. The data item is retained within the channel in a slot of a four-slot mechanism located in the memory of processor A (10), where it can be retrieved by the read access procedure (38) executing on processor A (10) at any time that the channel is not empty and can be updated by the write access procedure (34) executing on processor B (12) at any time that the channel is not full.

The activity (22) associated with the write access procedure (34) executing on processor B (12) assembles the data item that is to be inserted into the channel in a local slot in the memory of processor B (12) that can be accessed by the message-passing electronics ‘send’ process (18a). The write access procedure (34) then inspects the ‘full’ route-table variable (36b) in the particular row of the route-table (24) assigned to support this software-route, waiting if necessary when the channel is full. It then sets ‘full’ variable (36b) true and indicates that the data item is ready to be sent by setting the ‘primed’ bit (36a) true in the particular row of the route-table (24) assigned to support this software-route. The write access procedure (34) then waits until the message-passing electronics ‘send’ process (18a) indicates that the data item has been entered into the channel by setting the ‘primed’ bit (36a) false.

The first operation of the read access procedure (38) inspects the ‘empty’ route-table variable (36i) in the particular row of the route-table (24) assigned to support this software-route, waiting if necessary when the channel is empty. It then sets ‘empty’ bit (36i) true, executes the pre-read sequence on the four-slot mechanism and then obtains the slot number that contains the data item to be read. It then sets the ‘taken’ bit (36c) true, in the particular row of the route-table (24) assigned to support this software-route and then reads the data item from the identified slot. At some time later, the message-passing electronics ‘send’ process (18a) at Processor A (10) will send an acknowledgement message to indicate that the data item has been removed from the channel and sets the ‘taken’ bit (36c) false. On receipt of the acknowledge message, the message-passing electronics ‘receive’ process (18b) at Processor B (12) will set the ‘ack’ bit (36j) true. At some time later, the message-passing electronics ‘send’ process (18a) at Processor B (12) will set the ‘full’ bit (36b) false and the ‘ack’ bit (36j) false.

Referring again to FIG. 2 of the drawings, the route-table (24) according to an embodiment of the present invention includes an electronic circuit expressed by a two-dimensional array of design tiles (26), where each row of the array holds the variables needed to support the ends of two software-routes. As described earlier, the variables for one software-route end, are used by the message-passing electronics receive process (18b) and are associated with a software-route read access procedure (38). The variables for the other software-route end are used by the message-passing electronics send process (18a) and are associated with a software-route write access procedure (34).

As shown, each route-table row comprises ninety two columns:

Columns 0 to 39 hold in single bit form, the software-route data item length, the associated activity number and the base address of the four-slots in processor memory needed by the message-passing electronics receive process (18b) in order to allow it to autonomously deliver a particular software-route data item:

columns 0 to 5 hold the receive activity number
columns 6 to 26 hold the receive address
columns 27 to 39 hold the receive length

Column 40 holds the circuitry to (i) pre-select the row in the array that corresponds to the software-route number of the current software-route read or write access procedure (34, 38) and (ii) to pre-select the row in the array that corresponds to the software-route number of the current incoming software-route data item being dealt with by the message-passing electronics receive process (18b).

Column 41 holds the ‘empty’ bit (36i) that is used to indicate the empty condition for the read access procedure (38) for a software-route of type Channel or Signal.

Columns 42 to 46 hold the five single bits (36d-36h) of a four-slot mechanism, which as well as being used for the software-route pool protocol, also ensures that the message-passing receive process (18b) is never held up when needing to deliver a software-route data item:
column 42 holds the ‘r0’ bit (36h)
column 43 holds the ‘w0’ bit (36f)
column 44 holds the ‘ip’ bit (36d)
column 45 holds the ‘w1’ bit (36e)
column 46 holds the ‘r1’ bit (36g)

Column 47 holds the ‘ack’ bit (36j) that is used within the message-passing electronics (14) to allow the acknowledgement that a data item has been extracted from a software-route protocol at the receive process (18b) end of the bus or link (16) to be associated with the correct software-route number at the send process (18a) end of the link (16).

Column 48 holds the ‘taken’ bit (36c) that is used by a software-route read access (38) procedure to indicate that a data item has been extracted from a software-route of type Channel

Column 49 holds the ‘primed’ bit (36a) that is used to enable the write access procedure (34) of a software-route to initiate insertion of a data item.

Columns 50 and 51 hold the circuitry to select and to identify to the message-passing send process (18a), what software-route data item should be sent next.

Column 52 holds the ‘full’ bit (36b) that is used to indicate the full condition for the write access procedure (34) of a software-route of type Channel.

Columns 53 to 92 hold in single bit form, the data item length, the associated activity number and the address in processor memory needed by the message-passing electronics send process (18a) in order to allow it to autonomously extract from processor memory and send a particular software-route data item:
columns 53 to 65 hold the send length
columns 66 to 86 hold the send address
columns 87 to 92 hold the send activity number

As is shown in FIG. 2, connection between the route-table array and the software-route access procedures (34, 38) running on the processor is via a memory mapped processor interface circuit block (28a) at the top of the array. Similarly, connection between the array and the message-passing electronics (14) and the scheduling device (40) (e.g. butler) is via an interface circuit block (28b) at the bottom of the route-table array (24).

The configuration of the different types of design tiles (26) used in the route-table array (24) will now be described with reference to FIGS. 7 to 10.

In FIGS. 7 to 10, the lines, which represent physical connections, are named using the following convention. A line whose true Boolean value is represented by a positive voltage level is given a single-word name with an uppercase first letter and lowercase or numerical subsequent characters (e.g. Signal3). A line whose true Boolean value is represented by a zero voltage level is prefixed with an uppercase N (e.g. NSignal7). Where a line forms a connection between two tiles (26) in the same column it is post-fixed with an uppercase A or B (e.g. Signal4A is connected to Signal4B in the tile above, Signal4B is connected to Signal4A in the tile below). In FIGS. 8a, 8b and 8c, where a line forms a connection between two tiles (26) in the same row it is post-fixed with an uppercase L or R (e.g. Signal2L is connected to Signal2 or Signal2R in the tile to the left, Signal2R is connected to Signal2 or Signal2L in the tile to the right).

### Array Tile V

The configuration of Tile type V is shown in FIG. 7. The function of this tile is to allow concurrent, independent pre-selection of rows in the route-table array (24) by a software-route access procedure (34, 38) and by the message-passing electronics receive process (18b). The type V tile comprises a plurality of interconnected gates and input/output connections for interfacing with adjacent tiles in the route-table array (24) as shown in FIG. 2.

Each Tile V is customised according to its row number in the array and shown in FIG. 2 by using variants V0, V1, V2 and V3. The customising pattern ensures that only one row (i.e. the row for the software-route selected by the most recent “Select software-route number” software instruction) will establish NSselect low; and that only one row (i.e. the row selected by the message-passing electronics receive process (18b)) will establish NHselect low. V0, V1, V2 and V3 differ only in whether they invert the values on lines NSsel1A, NSsel2A, NSsel3A, Hsel3B, Hsel2B and Hsel1B or transmit their values unchanged: In V0 gates 2, 3, 4, 5, 6 and 7 invert; In V1 gates 2, 3, 6 and 7 invert and gates 4 and 5 do not invert; In V2 gates 2 and 7 invert and gates 3, 4, 5, and 6 do not invert; In V3 gates 2, 3, 4, 5, 6 and 7 do not invert.

### Array Tile X

The configuration of a version of Tile type X, X0 is shown in FIG. 8a. The function of this tile is to hold a one bit shared-variable value, the value of which can be independently and concurrently set or accessed by software-route access procedure instruction (34, 38) or by the message-passing electronics (14). The type X tile comprises a plurality of interconnected gates and input/output connections for interfacing with adjacent tiles in the route-table array as illustrated in FIG. 2.

Tile X includes an asynchronous set-reset latch (cross-coupled gates 11 and 12) for holding a single one-bit variable value. When it is in the row pre-selected by the most recent “Select software-route number” instruction (NSselect low), its value can be changed (Strue, Sfalse) or observed (NSout) by the software interface at the top of the array. When it is in the row pre-selected by the message-passing electronics (14) (NHselect low), its value can be changed (HtrueB, HfalseB) or observed (HoutB) by the hardware interface at the bottom of the array (28b).

The latch value will be established true via gate 18 when NSselect is low and StrueA is high and established false via gate 19 when NSselect is low and SfalseA is high (i.e. the value is written by software instruction to the software pre-selected route table row). The latch value will also be established true via gate 7 when NHselect is low and HtrueB is high and established false via gate 8 when NHselect is low and HfalseB is high (i.e. the value is written by the message-passing electronics to the message-passing electronics pre-selected route table row).

When NHselect is low, the latch value is transmitted to HoutB via gates 14 and 16 otherwise the value on HoutA is transmitted to HoutB via gates 6 and 16. This means that the latch value of the row pre-selected by the message-passing electronics will be established on HoutB at the bottom of the array.

When NSselect is low, the inverse latch value is transmitted to NSoutA via gates 15 and 13 otherwise the value on NSoutB is transmitted to NSoutA via gates 17 and 13. This means that the inverse latch value of the row pre-selected by the software will be established on NSoutA at the top of the array.

Each Tile X is customised according to its column number in the array and shown in FIG. 2 by using variants X0, X1, X2, X3 and X4.

The configuration of version X1 of tile type X is shown in FIG. 8b. It differs from version X0 in two aspects. Firstly, the latch (cross-coupled gates 11 and 12) value is made available at the right-hand side of the tile via connection ReadyR. Secondly the message-passing pre-select line (NHselect) is split into two: NHselectL allows the message-passing receive process (18b) to pre-select one array row to set the latch value true; whilst completely independently NHselect R allows the message-passing send process to pre-select one array row to set the latch value false.

The configuration of version X2 of tile type X is shown in FIG. 8c. It differs from version X0 in two aspects. Firstly, gate 1 is added, the output (ReadyR) of which will be true whenever the latch (cross-coupled gates 11 and 12) value is true or ReadyL is true. Secondly gates 4 and 5 on the message-passing pre-select line (NHselect) are reversed.

Version X4 of Tile type X is identical to version X0 shown in FIG. 8a but with unnecessary gates 7, 8, 13, 15, 17, 22, 23 and their associated connections removed.

Version X3 of Tile type X is identical to version X4 but with gates 4 and 5 on the message-passing pre-select line (NHselect) reversed.

The unused HoutA input for all tiles of type X in the top row, and unused NSoutB input for all tiles of type X in the bottom row, should be connected to the positive voltage level that is used to represent a Boolean value.

Tiles Y and Z are used to pre-select the row for use by the message-passing electronics ‘send’ process. In conjunction, the two tile-types enable the route-table to select which software-routes data item should be sent next. They incorporate the fully programmable, priority and round-robin butler-style selection logic that chooses the next software-route message when there is more than one with an outstanding data item ready to be sent.

### Array Tile Y

The configuration of Tile type Y is shown in FIG. 9. The function of this tile is to encode the selected route number. In addition, Tile Y enables designation of pollset boundaries for priority selection and the latching of ready and pollset conditions existing at a particular time in the software timeframe for subsequent use in the message-passing electronics send process (18a) timeframe. The type Y tile comprises a plurality of interconnected gates and input/output connections for interfacing with adjacent tiles in the route-table array as shown in FIG. 2. Each Tile Y is customised according to its row number in the array and shown in FIG. 2 by using variants Y0, Y1, Y2 and Y3. The customising pattern ensures that the row with NHselect low will establish its encoded row number on lines Rn3B, Rn2B, Rn1B and Rn0B at the bottom of the array. Y0, Y1, Y2 and Y3 differ only in whether they invert the values on lines Rn3A, Rn2A and Rn3 or transmit their values unchanged: In Y3 gates 2, 3, 4 invert; In Y2 gates 2 and 3 invert and gate 4 does not invert; In Y1 gate 2 inverts and gates 3 and 4 do not invert; In Y0 gates 2, 3 and 4 do not invert.

Cross-coupled two-input nand gates 16 and 17 form a one-bit ‘pollend’ latch. The latch value will be established true via gate 19 when NSselect is low and SpollA is high and established false via gate 18 when NSselect is low and CpollA is high. (i.e. the value is written by software instruction to a software-route pre-selected route-table row).

The four two-input nand gates 1, 21, 22 and 23 implement a special form of transparent latch as described in GB 2307365. This arrangement of gates will latch a correct value no matter what gate and wire delays are present in the physical layout. Lready will track the value of Ready whilst NSampleA is low but maintain its current value when NSample is high. The four two-input nand gates 12,13,14 and 15 implement the special form of transparent latch as described in GB 2307365. This arrangement of gates will latch a correct value no matter what gate and wire delays are present in the physical layout. NPollend will track the inverse value of the pollend latch whilst NSampleA is low but maintain its current value when NSample is high.

### Array Tile Z

The configuration of tile type Z is shown in FIG. 10. The function of this tile is to identify when the variables held in this row (software-route) are to be used for the message-passing electronics send process (18a). The type Z tile comprises a plurality of interconnected gates and input/output connections for interfacing with adjacent tiles in the route-table array as shown in FIG. 2.

NHselect will be established low in the row selected for use by the message-passing electronics send process (18a). The selection logic is similar to that used in the Butler (40) described in WO 97/22926. Lready will be high when this row has its ‘primed’ bit (36a) true, or its ‘ack’ bit (36j) true, or its ‘taken’ bit (36c) true, which indicates that this software-route needs servicing by the message passing electronics send process. NPollend will be low when this row has been designated as a poll-end boundary. Gate 1 forms the ‘last’ latch whose value is used by the selection logic in determining the start point for the round robin poll. The value of the ‘last’ latch is updated by a low-to-high transition on signal Last prior to the sending of each message. The logically identical signals Last and Last* are used to reduce gate loading by only driving the Gate 1 inputs in alternate rows. At the top of the array, Last and Last* (top row, column 51) are connected to the inputs of a two-input Nand gate, whose output is connected to NSampleA in tile Y (top row, column 50). The search chain loop is completed by connecting SearchuA to SearchdA in tile Z (top row, column 51) at the top of the array, and by connecting SearchdB to SearchuB in tile Z (bottom row, column 51) at the bottom of the array.

The NFoundA input in Tile Z (top row, column 51) should be connected to the positive voltage level that is used to represent a Boolean value. The LasffndA input in Tiles Z (top row, column 51), and NBottomB input in Tile Z (bottom row, column 51 should be connected to the zero voltage level that is used to represent a Boolean value.

As described earlier, circuit blocks at the top and bottom of the route-table array serve as interfaces between the array and the software-route access procedures running on the processor, and the route-table array and the message-passing electronics and the scheduling device (e.g. butler) respectively

The interface (28b) between the route-table (24) and a message-passing electronics receive process (18b) will now be described with reference to FIG. 11. When a message is received, a header will contain the encoded route-table number that has been inserted by the message-passing electronics send process (18a) at the other end of the bus or link (16). The encoded route-number is latched in the message passing-electronics receive process (18b) and fed via the interface to the HSel0, HSel1, HSel2 and HSel3 inputs on Tile_V (bottom row, column 40). This will pre-select the route-table row that contains the variables for the incoming message. The software-route data item length is provided to the message-passing electronics receive process (18b) on Hout in Tile X (bottom row, columns 27 to 39) and the base address of the four slots in processor memory is provided on Hout in Tile X (bottom row, columns 6 to 26).

The received message is delivered by the message-passing electronics (14) to one of four possible slots. The slot number (in the range 0 to 3) is defined by two signals named ip and w[ip], ip being the most significant bit. ip and w[ip] are derived from the four-slot variable values held in the pre-selected route-table row. ip is the value on Hout in Tile X (bottom row, column 44). When ip is low, w[ip] assumes the value (w0) on Hout in Tile X (bottom row, column 43). When ip is high, w[ip] assumes the value (w1) on Hout in Tile X (bottom row, column 45).

After the received message has been delivered, NPostwrite1 is pulsed low and some time later NPostwrite2 is pulsed low by the message-passing electronics receive process (18b). The two pulses are used to generate the post-write sequence to manipulate the control variables for the four-slot mechanism.

Gates 1, 2, 7, and 8 form a transparent latch as described in EP 96938370. When NPostwrite1 is high the latch is transparent and the output of gate 7 tracks the value (ip) on Hout in Tile X (bottom row, column 44). The low pulse on NPostwrite1 is routed to the inputs of gates 9 and 10. If the output of gate 7 (ip) is low then the output of gate 9 is pulsed high, if the output of gate 7 (ip) is high then the output of gate 10 is pulsed high. This implements ip:=not(ip) for the received message software-route. The transparent latch is included to prevent a potential race condition when the ip variable value is being updated.

The low pulse on NPostwrite2 is routed to the inputs of gates 5, 6, 11 and 12. When the output of gate 7 (ip) is low, the output of gate 5 is pulsed high if (r0) Hout in Tile X (bottom row, column 42) is low, but the output of gate 6 is pulsed high if it is high. When the output of gate 7 (ip) is high, the output of gate 11 is pulsed high if (r1) Hout in Tile X (bottom row, column 46) is low, but the output of gate 12 is pulsed high if it is high. This implements w[ip]:=not(r[ip]) for the received message software-route.

The low pulse on NPostwrite2 is also routed to the inputs of gates 4 and 21. The output of gate 4 is pulsed high to make the ‘empty’ bit (36i) false for the received message software-route. The output of gate 21 is pulsed low to stim the butler to reactivate a potential de-scheduled waiting activity. The activity number is provided on Hout in Tile X (bottom row, columns 0 to 5).

A low pulse from the message-passing electronics receive process (18b) on NSetack is routed via gate 19 to make ‘(36j)’ true for the pre-selected route-table row, when the incoming message is an acknowledgement message.

The interface between the message-passing electronics send process (18a) and the route-table (24) will now be described with reference to FIG. 12. Prior to sending a message NNextmess is pulsed low by the message-passing electronics send process (18a). The route-table (24) uses this pulse to pre-select the route table row that contains the control variables for the next message to be sent. The value on NNextmess is transmitted to Last and Last* via gates 2 and 1. (The logically identical signals Last and Last* are used to reduce gate loading).

The inverse values of the control variables ‘ack’ (36j), ‘taken’ (36c), and ‘primed’ (36a) for the pre-selected route-table row are transmitted to the message-passing electronics send process (18a) via gates 3, 4 and 5.

A low pulse from the message-passing electronics send process (18a) on NClrack is routed to make ‘ack’ (36j) false and ‘full’ (36b) false for the pre-selected route-table row. The pulse is also routed via gate 8 to stim the Butler (40) to reactivate a potential de-scheduled waiting activity. The activity number is provided on Hout in Tile X (bottom row, columns 87 to 92).

A low pulse from the message-passing electronics send process (18a) on NClrtaken is routed via gate 6 to make ‘taken’ (36c) false for the pre-selected route-table row.

A low pulse from the message-passing electronics send process (18a) on NClrprimed is routed to make ‘primed’ (36a) false for the pre-selected route-table row. The pulse is also routed via gate 8 to stim the butler to reactivate a potential de-scheduled waiting activity. The activity number is provided on Hout in Tile X (bottom row, columns 87 to 92).

The interface between the route-table and the software is via a memory-mapped processor interface at the top of the array and is in shown in FIGS. 13, 14 and 15.

Route-table operations are carried out in response to memory accesses. Writes to, and reads from the route-table are used to load variable values, return variable values to the processor and to initiate internal route table operations.

| ADDRESS | | | | | |
|---|---|---|---|---|---|
| A3 | A2 | A1 | A0 | WRITE | READ |
| 0 | 0 | 0 | 0 | Select software-route number | Slot_number |
| 0 | 0 | 0 | 1 | Address_receive | Slot_number |
| 0 | 0 | 1 | 0 | Address_send | Slot_number |
| 0 | 1 | 0 | 0 | Length_receive | Slot_number |
| 0 | 1 | 0 | 1 | Length_send | Slot_number |
| 0 | 1 | 1 | 0 | Activity_receive | Slot_number |
| 0 | 1 | 1 | 1 | Activity_send | Slot_number |
| 1 | 0 | 0 | 0 | Primed | Primed? |
| 1 | 0 | 0 | 1 | Full | Full? |
| 1 | 0 | 1 | 0 | Empty | Empty? |
| 1 | 0 | 1 | 1 | Taken | Slot_number |
| 1 | 1 | 0 | 1 | Pollend | Slot_number |
| 1 | 1 | 1 | 0 | Pre-read_one | Slot_number |
| 1 | 1 | 1 | 1 | Pre-read_two | Slot_number |

FIG. 13 shows how four processor bus address lines (A0 to A3) are decoded (NA0000 to NA1111) and gated with the processor bus route-table write strobe (Nroutetablewrite) to create a pulse on one of the lines W0000 to W111. Twenty-six bits of the processor data bus are double buffered to produce D0 to D25 and their complimentary values ND0 to ND25. W0000 is fed to four similar circuits, each of which includes four two-input nand gates, which form a transparent latch as described in GB 2307365. The four circuits will latch the values on buffered processor data lines D0 to D3 each time the processor writes to route-table address 0000. The inverted latched values are fed to NSsel0 to NSsel3 in Tile V0 (top row, column 40), which will preselect a row in the route-table. Subsequent software instruction accesses to the route-table will operate on this pre-selected row, which corresponds with the software-route number.

FIG. 14 shows how the pulses created in FIG. 13 each time the processor writes to the route-table are gated with the buffered data lines and steered to the appropriate column in the array.

When the processor writes to route-table address 0001 the base address for the four-slots for received data items associated with the pre-selected software-route number is loaded into the array. The values on the buffered data lines are used to steer the W0001 pulse to the Strue or Sfalse inputs in Tile X3 (top row, columns 6 to 26). When the processor writes to route-table address 0010 the address of the slot for sending data items associated with the pre-selected software-route number is loaded into the array. The values on the buffered data lines are used to steer the W0010 pulse to the Strue or Sfalse inputs in Tile X4 (top row, columns 66 to 86).

When the processor writes to route-table address 0100 the length for received data items associated with the pre-selected software-route number is loaded into the array. The values on the buffered data lines are used to steer the W0100 pulse to the Strue or Sfalse inputs in Tile X3 (top row, columns 27 to 39). When the processor writes to route-table address 0101 the length of data items to be sent on the pre-selected software-route number is loaded into the array. The values on the buffered data lines are used to steer the W0101 pulse to the Strue or Sfalse inputs in Tile X4 (top row, columns 53 to 65).

When the processor writes to route-table address 0110 the activity number for received data items associated with the pre-selected software-route number is loaded into the array. The values on the buffered data lines are used to steer the W0110 pulse to the Strue or Sfalse inputs in Tile X3 (top row, columns 0 to 5). When the processor writes to route-table address 0111 the activity number associated with the data items to be sent on the pre-selected software-route number is loaded into the array. The values on the buffered data lines are used to steer the W0111 pulse to the Strue or Sfalse inputs in Tile X4 (top row, columns 87 to 92).

When the processor writes to route-table address 1000 the primed bit (36a) value for the pre-selected software-route number is loaded into the array. The values on buffered data lines D0 and ND0 are used to steer the W1000 pulse to the Strue or Sfalse input in Tile X2 (top row, column 49).

When the processor writes to route-table address 1001 the full bit (36b) value for the pre-selected software-route number is loaded into the array. The values on buffered data lines D0 and ND0 are used to steer the W1001 pulse to the Strue or Sfalse input in Tile X0 (top row, column 52).

When the processor writes to route-table address 1010 the empty bit value for the pre-selected software-route number is loaded into the array. The values on buffered data lines D0 and ND0 are used to steer the W1010 pulse to the Strue or Sfalse input in Tile X0 (top row, column 41).

When the processor writes to route-table address 1011 the taken bit (36c) value for the pre-selected software-route number is loaded into the array. The values on buffered data lines D0 and ND0 are used to steer the W 011 pulse to the Strue or Sfalse input in Tile X2 (top row, column 48).

When the processor writes to route-table address 1101 the pollend bit value for the pre-selected software-route number is loaded into the array. The values on buffered data lines D0 and ND0 are used to steer the W1101 pulse to the Strue (Spoll) or Sfalse (Cpoll) input in Tile Y0 (top row, column 50). Pollends are used to allocate priority levels to individual or groups of rows within each route table in the same way as for the butler.

When the processor writes to route-table address 1110 the route-table executes the four-slot logic operation r:=w for the pre-selected software-route number. (It is a parallel operation which concurrently makes the assignments r0:=w0 and r1:=w1). The values w0 on NSout in tile X0 (top row column 43) and w1 on NSout in tile X0 (top row column 45) are used to steer the W1110 pulse to the Strue or Sfalse inputs for r0 and r1 in Tile X0 (top row, column2 42 and 46). Two transparent latches of the form described in EP 96938370 are included to prevent a potential race condition whilst the r:=w update is in progress.

When the processor writes to route-table address 1111 the route-table executes the four-slot logic operation op:=not(op) for the pre-selected software-route number. However, in this implementation the value of op is only used once in a short uninterruptible sequence of software-route read access procedure instructions and so it is not necessary to store the individual op value for all software routes in the array. The op:=not(op) operation is covered in the processor reading interface described below.

FIG. 15 shows the processor reading interface to the route-table. The processor route-table read strobe is used to enable a set of tri-state output buffers to drive bits 0 to 31 on the processor data bus. An uninterruptible sequence of software instructions is used to execute the four-slot reading algorithm and obtain the slot number that the software reading process should next read from. The sequence of instructions Select software-route number, Pre-read_one, Pre-read_two, Slot_number, will return the slot number (0,1,2 or 3) that should be used to access the message data for the selected software-route number. When the processor writes to route-table address 1111 (Pre-read 2) the route-table executes the four-slot logic operation op:=not(op) for the pre-selected software-route. The W1111 pulse latches the value of Nip, the value of NSout on TileX0 (top row, column 44), using a transparent latch of the form described in EP 96938370. The latched value is then op, the most significant of two bits identifying the slot number to be read from. Any route-table read instruction will then return the slot number on the processor data bus bits 1 and 0: Bit 1 will be the latched op value; Bit 0 will be r[op] which is r1, the inverted value on NSout from Tile X0 (top row, column 46) if op is true but r0, the inverted value on NSout from Tile X0 (top row, column 42) if op is false.

When the processor reads from route-table address 1000 (Instruction Primed?) the route-table will return a high value on processor data bus bit D31 when the ‘primed’ variable (36a) for the pre-selected route-table entry is false. When the processor reads from route-table address 1001 (Instruction Full?) the route-table will return a high value on processor data bus bit D31 when the ‘full’ variable (36b) for the pre-selected route-table entry is false. When the processor reads from route-table address 1011 (Instruction Empty?) the route-table will return a high value on processor data bus bit D31 when the ‘empty’ variable (36i) for the pre-selected route-table entry is false.

In summary, the invention relates to a route-table, suitable for use in a real-time multiple-processor environment that includes any form of message-passing electronics, e.g. buses or links. It is used to allow a particular message-passing path (bus or link) to support a set of the software-routes, between pairs of interacting activities executing in different processors, without the need for a complex operating system. In addition to facilitating the autonomous movement of data associated with each software-route interaction protocol by the message-passing electronics, it also includes the variables necessary to implement various software-route protocols.

1. A distributed processing environment for supporting the execution of interacting activities in different processors, comprising
a network of message-passing elements for transferring data between memory areas of the processors; characterized by
route-table means associated with each message-passing element within the distributed processing environment, the route-table means comprising
programmable variables for a set of software-routes that are to be supported by the associated message-passing device, wherein software-route data associated with a software activity producing data and a software activity using the data is transferable between memory devices concurrently with execution of activities by the processors.

2. A real-time distributed processing environment according to claim 1, wherein the route-table includes a separate set of variables for each software-route supported.

3. A real-time distributed processing environment according to claim 1, wherein the programmable variables comprise software-route data item location, software-route data item length and identification of the connected software activity for each end of a software-route.

4. A real-time distributed processing environment according to claim 3, wherein the data item location comprises the address in processor memory of one or more slots that a software-route data item is to be read from or written to.

5. A real-time distributed processing environment according to claim 4, wherein a four slot mechanism is operative to ensure that concurrent reading of a data item during execution of a software-route read access procedure and the writing of a data item by the message-passing electronics are directed to different slots.

6. A real-time distributed processing environment according to claim 1, wherein the route-table includes single-bit control variables that are dynamically updated during the execution of a software-route read access procedure or a software-route write access procedure.

7. A real-time distributed processing environment according to claim 1, wherein the route-table includes single-bit control variables that are dynamically updated by the message passing electronics.

8. A real-time distributed processing environment according to claim 6, wherein at least some of the single-bit control variables are shared variables that are dynamically updated during the execution of a software-route read access procedure or a software-route write access procedure or by the message-passing electronics.

9. A real-time distributed processing environment according to claim 1, wherein the route-table includes single-bit control variables and the values of particular control variables are updated by the message-passing electronics during a post-write sequence to indicate that a new data item has been added to memory.

10. A real-time distributed processing environment according to claim 1, wherein the route-table includes single-bit control variables and the values of particular control variables are updated during a post-write sequence to identify the slot in memory to be used for delivery of the next data item received on the software-route by the message-passing electronics.

11. A real-time distributed processing environment according to claim 1, wherein the route-table includes single-bit control variables and the values of control variables are updated during a pre-read sequence by a software-route read access procedure to indicate the slot in memory that should be read.

12. A real-time distributed processing environment according to claim 1, further comprising scheduling means arranged to select activities for execution according to a predefined priority scheme.

13. A real-time distributed processing environment according to claim 12, wherein the scheduling means is arranged to deschedule execution of an activity that is temporally blocked by a software-route protocol.

14. A real-time distributed processing environment according to claim 12, wherein the scheduling means is arranged to associate each software-route end with a stim-wait channel for the particular activity to which the software route is connected.

15. A real-time distributed processing environment according to claim 1, wherein the route-table comprises an integrated circuit that is defined by a series of interconnected design tiles, the design tiles being arranged in an array of rows and columns.

16. A real-time distributed processing environment according to claim 15, wherein each row of the array holds the variables associated with the message-passing elements send process of a first software-route and the message-passing elements receive process of a second software-route.

17. A real-time distributed processing environment according to claim 1, comprising a separate route-table provided at each interface between a processor and its connection point to the network of message passing elements.

18. A real-time distributed processing environment according to claim 17, further comprising first interface means arranged to allow interaction between the route-table and software-route access procedures associated with activities running on the processors.

19. A real-time distributed processing environment according to claim 18, further comprising second interface means arranged to allow interaction between the route-table and the associated message-passing elements.

20. A real-time distributed processing environment according to claim 18, wherein the first interface means includes circuitry arranged to preselect the route-table row that holds the control variables for a particular software-route.

21. A real-time distributed processing environment according to claim 19, wherein the second interface means includes circuitry arranged to preselect the route-table row for the message-passing electronics receive process that holds the control variables for a particular software-route.

22. A real-time distributed processing environment according to claim 1, wherein the route-table means includes circuitry arranged to preselect the route-table row for the message-passing elements send process that holds the control variables for a particular software-route.

23. A method of transferring software-route data between interacting activities being executed on different processors in a real-time distributed processing environment comprising
holding variables for each software-route supported by the message-passing elements between the processors;
presenting variables for a read access procedure associated with an activity of a first software-route to the message-passing elements;
presenting variables for a write access procedure associated with an activity of a second software-route to the message-passing elements;
transferring the software-route data item associated with the read access procedure of first software-route and the write access procedure of the second software-route; and
executing an activity on either or both processors, wherein the transfer of data and the execution of the activity are concurrent.

24. A method according to claim 23, further comprising updating the values of particular control variables by the message-passing elements during a post-write sequence to indicate that a new data item has been added to memory.

25. A method according to claim 23, further comprising updating the values of particular control variables during a post-write sequence to identify the slot in memory to be used for delivery of the next data item received on the software-route by the message-passing electronics.

26. A method according to claim 23, wherein the values of control variables are updated during a pre-read sequence by a software-route read access procedure to indicate the slot in memory that should be read.

27. A method according to claim 23, further comprising scheduling activities for execution according to a predefined priority scheme.

28. A method according to claim 27, comprising descheduling execution of a scheduled activity that is temporally blocked by a software-route protocol.
